(19) United States
(12) Patent Application Publication
(10) Pub. No.: US 2018/0145715 A1
(43) Pub. Date: May 24, 2018

(54) TOOL FOR APPLYING PROTECTIVE FILMS TO MOBILE COMMUNICATIONS DEVICES

(71) Applicant: Alex Abadi, Austin, TX (US)

(72) Inventor: Alex Abadi, Austin, TX (US)

(73) Assignee: Microstrate Inc., Kyle, TX (US)

(21) Appl. No.: 15/691,697

(22) Filed: Aug. 30, 2017

Related U.S. Application Data
(60) Provisional application No. 62/381,068, filed on Aug. 30, 2016.

(51) Int. Cl. H04B 1/3888; B29C 63/00

(52) U.S. Cl. CPC H04B 1/3888; B29L 2031/3475; B29C 63/0004

(57) ABSTRACT

In combination with a mobile communications device equipped with a display, and a film equipped with an adhesive backing and a release liner, a tool is provided for applying the film to the display. The tool includes a substrate having a depression therein in which the mobile communications device is seated; first and second opposing rails disposed on opposing sides of the depression; and a film applicator which travels along the first and second rails. The film applicator is equipped with first and second wheels which engage the first and second rails, respectively, and is further equipped with a blade which pressingly engages the film as the film applicator which travels along the first and second rails.

### CROSS-REFERENCE TO RELATED APPLICATION

This application claims the benefit of priority from U.S. provisional application No. 62/381,068, filed Aug. 30, 2016, having the same inventor and the same title, and which is incorporated herein by referenced in its entirety.

### FIELD OF THE DISCLOSURE

The present disclosure relates generally to protective films for displays, and more particularly to devices and methodologies for applying protective films to the displays of mobile technology platforms.

### BACKGROUND OF THE DISCLOSURE

Mobile phones and other mobile technology platforms have become ubiquitous in modern society. The ability of these devices to provide mobile network access and communications abilities has opened up new modes of content and service consumption, and has provided users with new and unique ways to interact with the world around them.

However, because of their mobility and size, mobile technology platforms are commonly subjected to environmental hazards that are not shared by their desktop counterparts. For example, users frequently place mobile technology platforms in pockets, purses, cup holders, drawers, on countertops, and in other such locations where they may come into contact with various other objects or surfaces. Over time, this may cause the display of the device to become scratched or abraded.

In light of the foregoing, it has now become common to apply a protective film to the exterior surface of the displays on mobile technology platforms. In addition to protecting the surface of the display from environmental hazards, these films may also improve the optical characteristics of the display. Thus, for example, such films may imparting polarizing capabilities thereto which reduce or eliminate glare, or may enhance privacy or increase the brightness of the display.

Various film applicators have been developed in the art for applying protective films to the displays of mobile technology platforms. Many of these devices are small, hand-operated devices which are intended for use by consumers in the aftermarket.

For example, U.S. 2015/0314523 (Mason et al.) describes an applicator for applying protective films to electronic device displays. The applicator 1, which is depicted in FIG. 1, includes a base 5, a screen protector 21, and a squeegee 55. The base 5 includes a pocket 13 for receiving an electronic device 83. The screen protector 21 is affixed to the base 5 so as to overlie an electronic device 83.

As seen in FIG. 7, the screen protector 21 includes a protective film 27 sandwiched between a back liner 33 and a cap sheet 41. The protective film 27 has a lower adhesive side 29 intended to affix to an electronic device display 83 (see FIG. 1) and an upper exterior surface 31 for protecting the electronic device 81 (see FIG. 1). The screen protector's back liner 33 has a lower side 37 and an adhesive side 35 which loosely adheres to the protective films adhesive side 29. The third layer of the protective film 27 is the cap sheet 41. The cap sheet 41 has a lower adhesive side 43 which loosely adheres to the protective films upper exterior surface 31. The squeegee 55 (see, e.g., FIG. 2) is provided for removing the back liner 33 and for simultaneously affixing the protective film 27 to the electronic device 83.

In use, as shown in FIG. 1, the screen protector's first end 23 is affixed to the base's first end 7 so as to allow the screen protector to overlie the base's first pocket 13. As seen in FIG. 1, the screen protector 21 is affixed to the base by providing one or more layers of the screen protector with an edge portion 39 which extends to cover and adhere to the base's upper surface 11 at its first end 7.

The applicator 1 further includes a squeegee 55 which is preferably positioned within the base's second pocket 15. The squeegee 55 has a substantially planar bottom surface 57 and a slot 59 which is angled relative to the squeegee's bottom surface 57. Preferably, the squeegee 55 includes an angled front side 61 forming the front side of the slot 59.

To apply a protective film 27 to an electronic device display 83, as seen in FIG. 2, the screen protector 21 is folded backwardly to allow insertion of an electronic device 81 into the base's first pocket 13. The electronic device is positioned within the first pocket 13. Thereafter, as illustrated in FIG. 3, the screen protector's second end is inserted and made to pass through the squeegee's slot 59. The screen protector is inserted into the squeegee's slot 59 so as to allow the squeegee's bottom surface 57 to engage the base's upper surface 11.

As illustrated in FIG. 4, once the squeegee 55 has slid the length of the screen protector 21 so as to engage the base at its first end 7, the screen protector 21 is folded backwardly. When the screen protector 21 has been folded back at an angle between the squeegee's bottom surface 57 and slot 59, the screen protector's back liner 33 is made to crack and peel from the protective film 27. Thereafter, as illustrated in FIG. 5, the squeegee 55 is slid across the base's upper surface 11 and the electronic device's display 83 so as to cause the back liner 33 to peel away from the protective film 27. The squeegee purportedly forces out any bubbles between the protective film 27 and the electronic device's display 83. Once the squeegee has completely slid across the electronic device, the base liner 33 has been forced to peel away completely from the protective film 27 leaving the protective film securely adhered to the electronic device 81.

With reference to FIG. 6, once the back liner has been removed from the protective film, the cap sheet 41 is removed from the protective film by peeling one end of the cap sheet 41 away from the protective film 27 until the cap sheet has been completely removed.

### BRIEF DESCRIPTION OF THE DRAWINGS

FIG. 1 is a perspective view of a first prior art device for applying a protective film to a mobile communications device.

FIGS. 2-6 are perspective views illustrating the method for using the device of FIG. 1.

FIG. 7 is a perspective view of a 3-piece protective film useful in both the device of FIG. 1 and in the devices and methodologies disclosed herein.

FIGS. 8-15 are perspective views of a second prior art device for applying a protective film to a mobile communications device.

FIG. 16 is a perspective view of a third prior art device for applying a protective film to a mobile communications device.

FIGS. 17-22 are perspective views of a first particular, non-limiting embodiment of a device in accordance with the teachings herein for applying a protective film to a mobile communications device.

FIGS. 23-35 are perspective views of a second particular, non-limiting embodiment of a device in accordance with the teachings herein for applying a protective film to a mobile communications device.

FIGS. 36-49 are perspective views of a third particular, non-limiting embodiment of a device in accordance with the teachings herein for applying a protective film to a mobile communications device.

FIG. 50 is a perspective view of a template which may be used with the devices disclosed herein to accommodate mobile devices having different form factors.

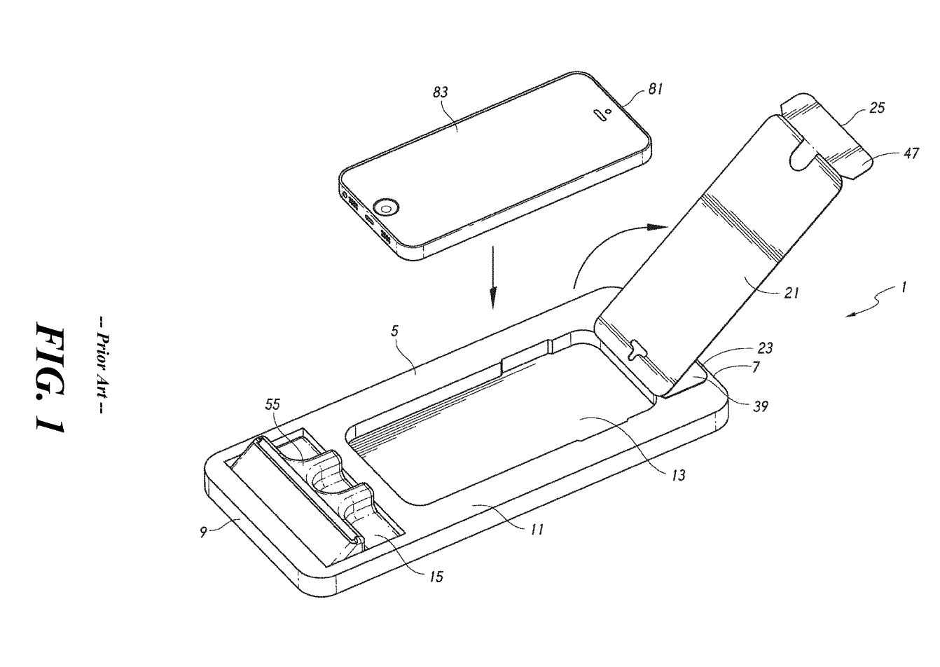

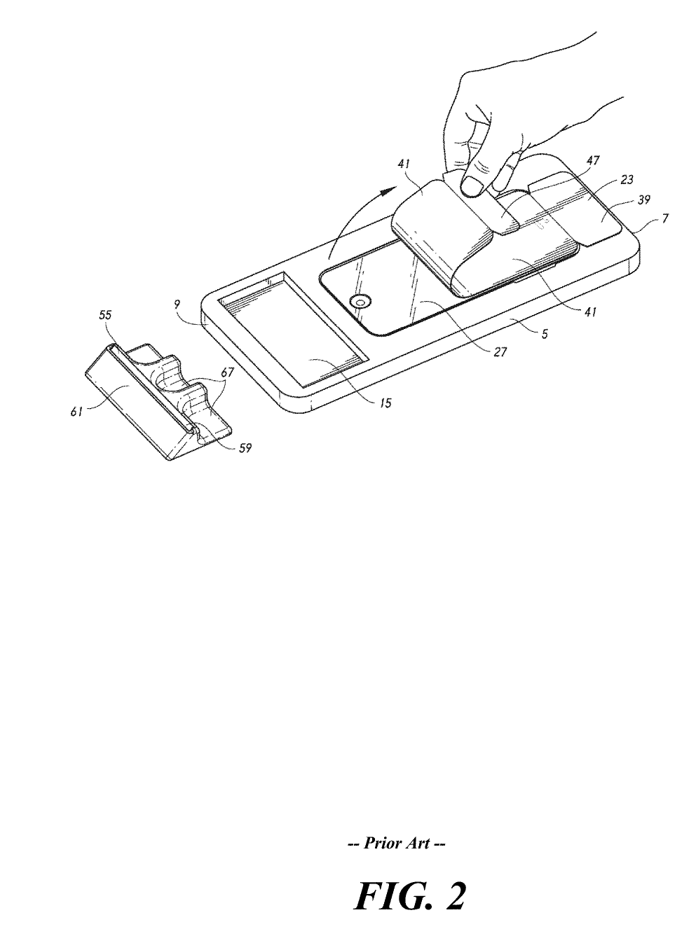

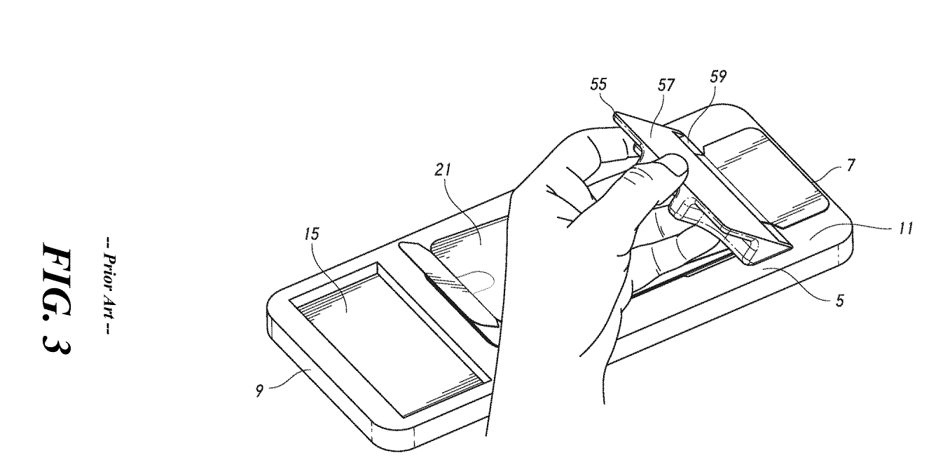

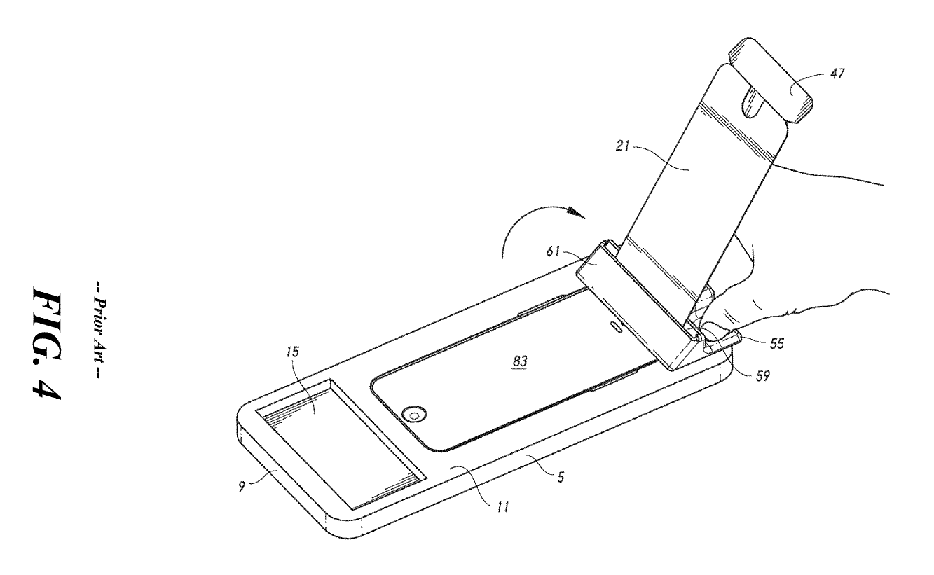

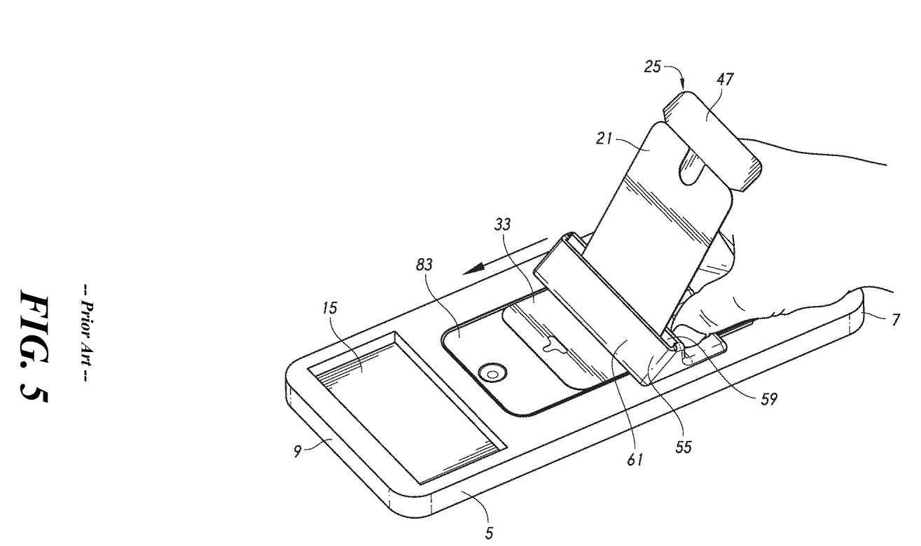

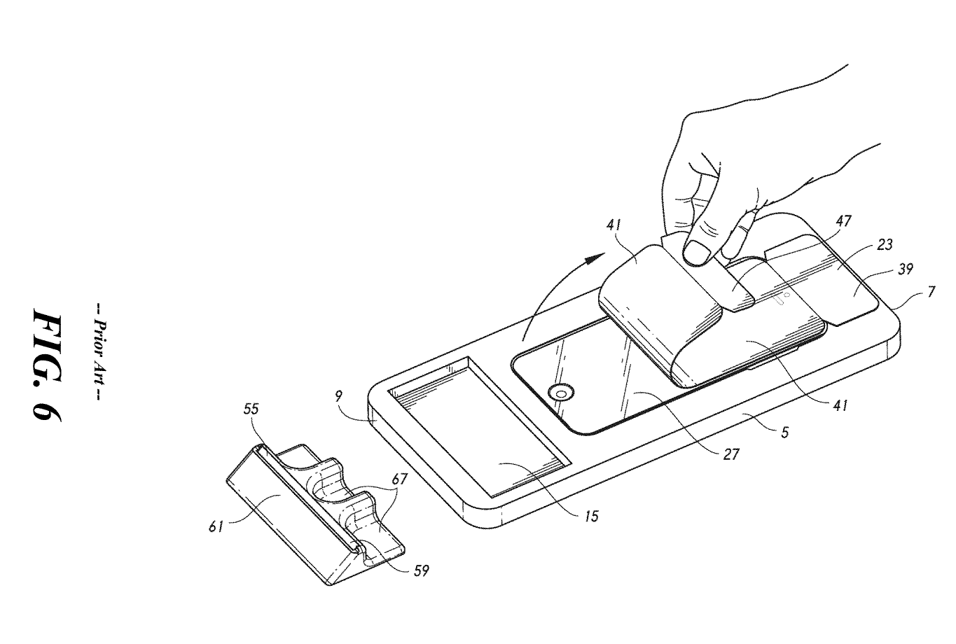

### SUMMARY OF THE DISCLOSURE

In one aspect, a combination is provided comprising a mobile communications device equipped with a display, a film equipped with an adhesive backing and a release liner, and a tool for applying the film to the display. The tool comprises (a) a substrate having a depression therein in which the mobile communications device is seated; (b) first and second opposing rails disposed on opposing sides of said depression; and (c) a film applicator which travels along said first and second rails; wherein the film applicator is equipped with (i) first and second wheels which engage said first and second rails, respectively, and (ii) a blade which pressingly engages said film as the film applicator which travels along said first and second rails.

In another aspect, a combination is provided comprising a mobile communications device equipped with a display, a film equipped with an adhesive backing and a release liner, and a tool for applying the film to the display. The tool comprises (a) a substrate having a depression therein in which the mobile communications device is seated; (b) first and second opposing, toothed rails disposed on opposing sides of said depression; (c) a film applicator which travels along said first and second rails and which, in doing so, pressingly engages the film against the display; wherein the film applicator is equipped with (i) first and second toothed gears which mesh with said first and second rails, respectively, and (ii) a blade which pressingly engages said film.

In a further aspect, a combination is provided comprising a mobile communications device equipped with a display, a film equipped with an adhesive backing and a release liner, and a tool for applying the film to the display. The tool comprises (a) a substrate having a depression therein in which the mobile communications device is seated; (b) first and second opposing walls disposed on first and second opposing sides of said depression, wherein each of said first and second opposing walls has first and second longitudinal slots therein; and (c) a film applicator which is equipped with a blade and which is further equipped with first and second axles, wherein the end portions of said first and second axles slidingly engage said first and second slots, and wherein said blade pressingly engages said film as the film applicator travels along said first and second longitudinal slots.

### DETAILED DESCRIPTION

While devices such as that disclosed in Mason et al. may have some desirable attributes, in practice, devices of this type do a poor job of applying protective films to the displays of mobile technology platforms, especially in the hands of inexperienced users. In particular, the squeegee utilized in these devices is not constrained in a lateral direction. Consequently, the use of such devices frequently results in films that are improperly oriented with respect to the underlying display. It is also found that these devices do an incomplete job of removing air bubbles from the protective film, which is highly objectionable to users of mobile technology platforms.

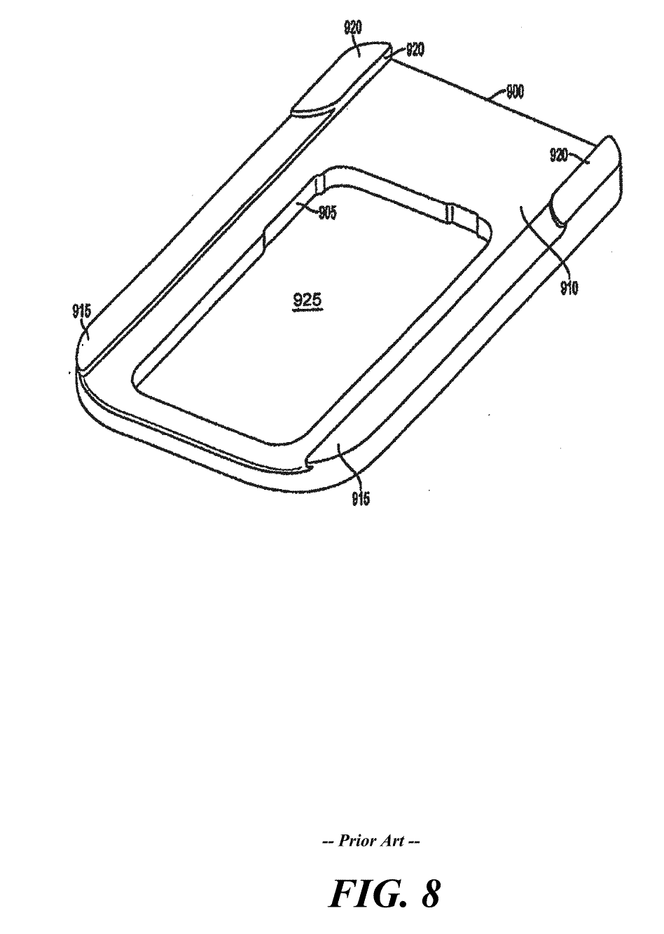

Some attempts have been made in the art to attempt to address the foregoing infirmities. For example, U.S. 2014/0230988 (Chou) discloses a screen protector application system for applying a protective film to a surface of a mobile communication device. As illustrated in FIG. 8, the system disclosed therein includes a roller apparatus guide 900 which includes an inner wall 905 defining a cavity 925 used to receive or mount a mobile communication device, a roller supporting surface 910 configured to be flush with a mounted mobile communication device, and a set of roller guiding rails 915 which may be parallel to one another and raised above the roller supporting surface 910. In addition, the roller apparatus guide 900 may include pressing portions 920 to assist the user when applying the protective film.

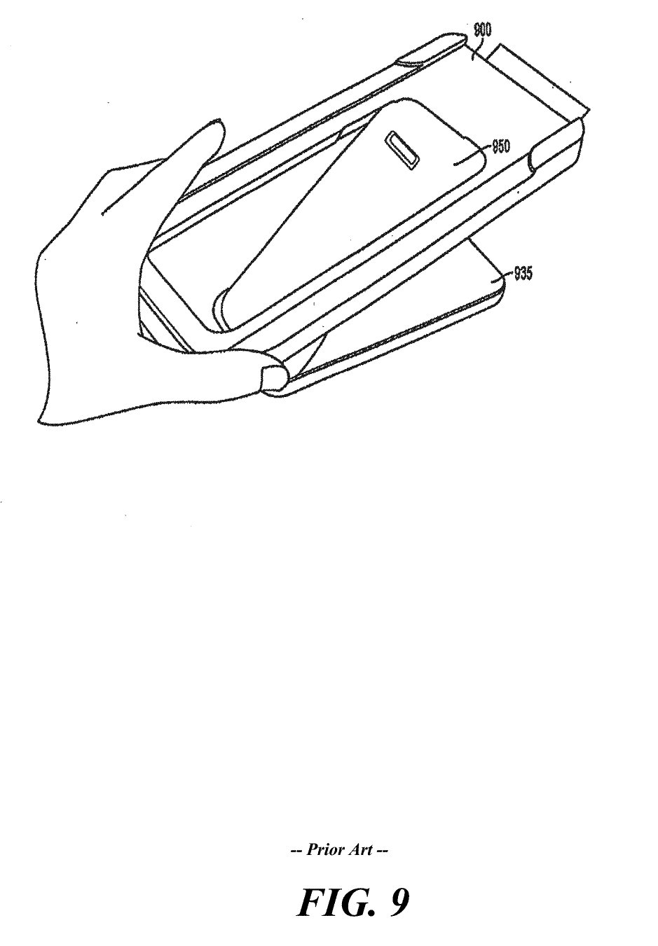

FIG. 9 illustrates the roller apparatus guide 900, a film 950 to be applied, and a mobile communication device 935. The film 950 may be temporarily held to the roller apparatus guide 900 via an adhesive (not shown). As the film 950 is sized to correspond to the mobile communication device 935 (which is to be inserted or mounted by the roller apparatus guide 900), the film 950 may freely move in and out of the cavity 925 as shown.

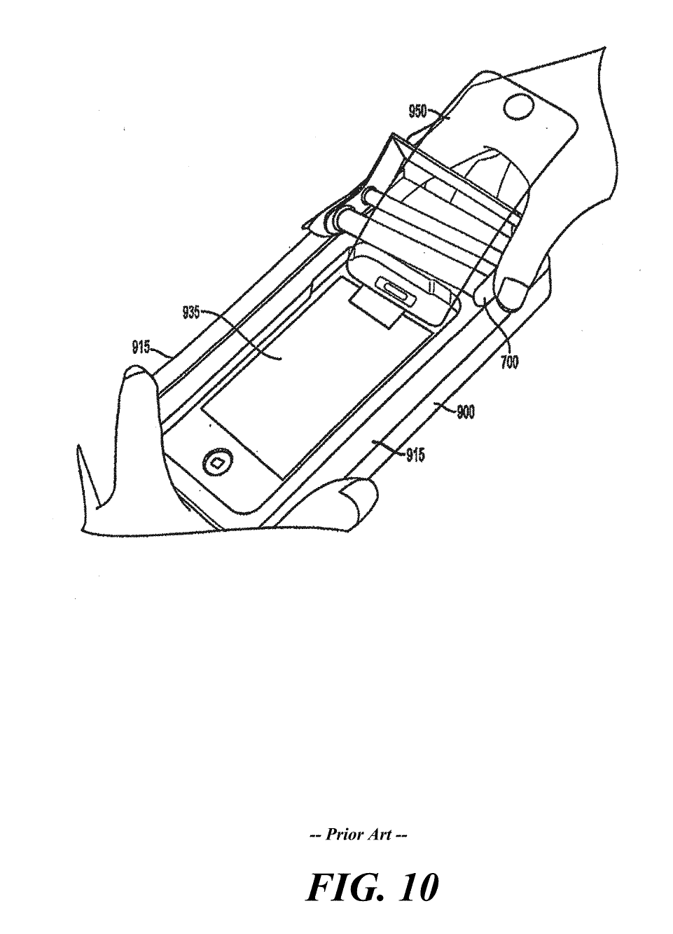

FIG. 10 illustrates the roller apparatus guide 900 fully mounted on the mobile communication device 935, and with the film 950 in a ready-to-be-applied position. The roller 700 may be placed at the top of the roller apparatus guide 900, with the film-contacting outer cores held between the roller guiding rails 915. The distance between the roller guiding rails 915 may be configured to be the same as the length of the roller 700 thereby forming a path for the movement of the roller 700 along a surface of the mobile communication device 935. In other words, the roller guiding rails 915 create a pathway to prevent the roller 700 from veering off the intended positional direction of application, and thus purportedly ensuring that the film 950 is applied at a correct position and purportedly providing a simplified methodology for imparting the desired precision during the film application process.

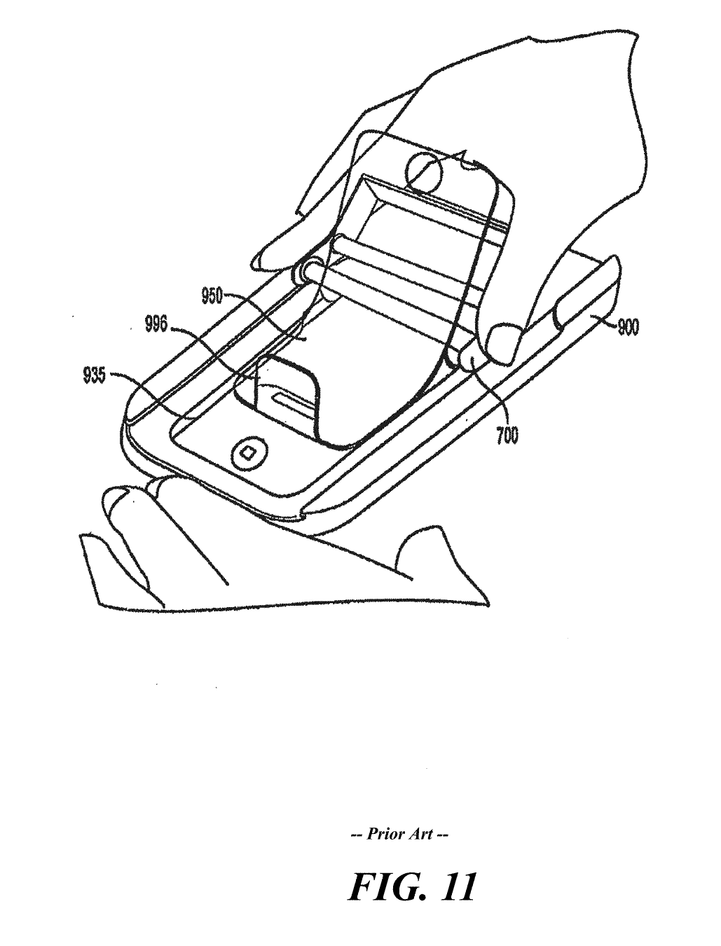

As shown in FIG. 11, after the user pulls a film tab 996 to expose the protective layer of the film 950 and as the user begins to move the roller 700 from one end of the mobile communication device 935 to the other end of the mobile communication device 935 in the direction of arrow 955, the backing of the film 950 is automatically removed while the exposed protective film is applied to the mobile communication device 935.

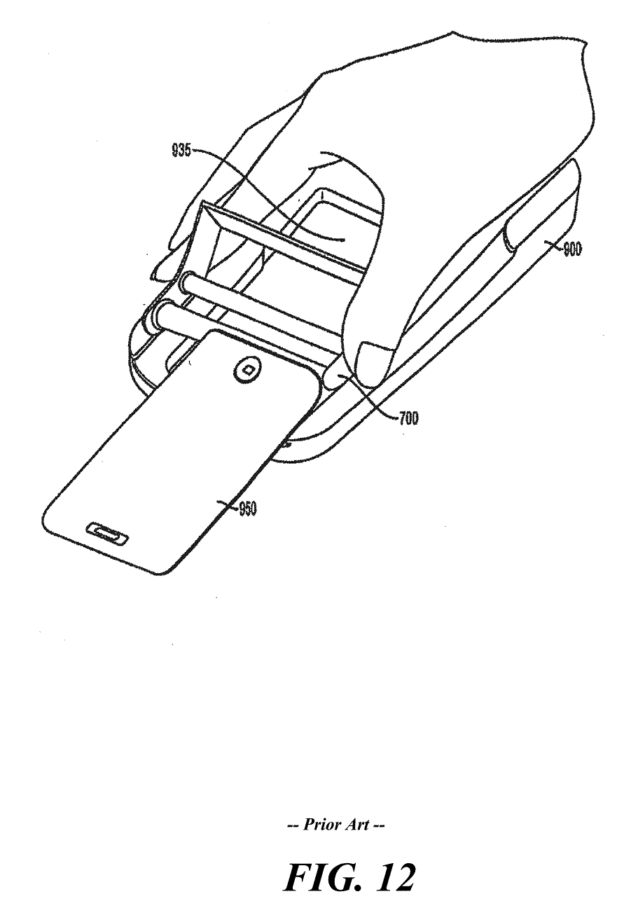

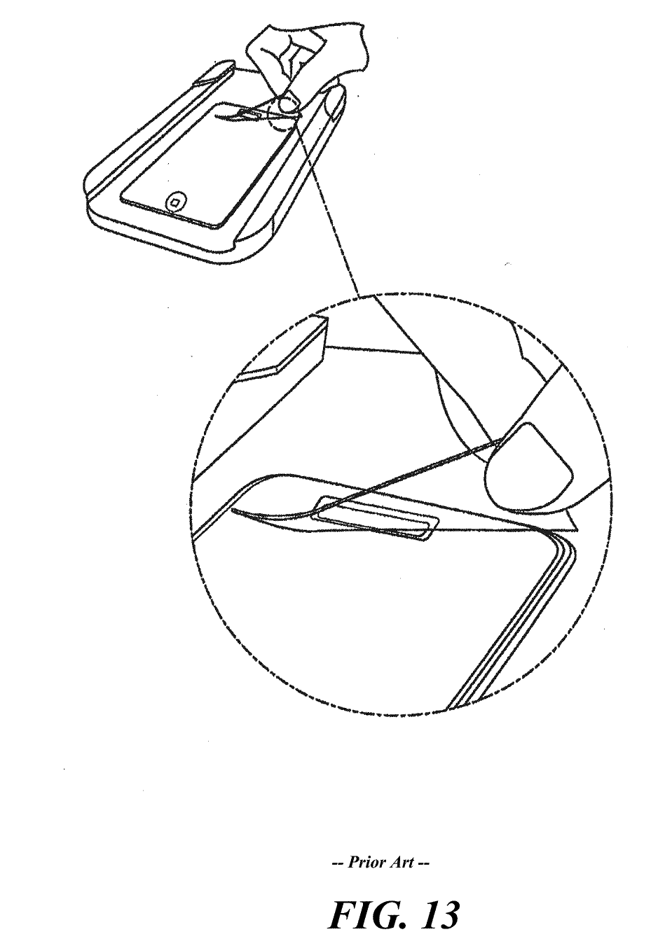

FIG. 12 illustrates the roller 700 as the user is about to conclude application of the film 950. As shown, the film backing of the film 950 is substantially separated from the applied portion of the film 950. As shown in FIG. 13, after the user finishes using the roller 700 to apply the film when the electronic device 935 is situated within the roller guide apparatus 900, the user may remove any adhesive tabs that may have been used to attach the film 900 to the roller guide apparatus 900 for ease of positioning of the film 950 during the application process.

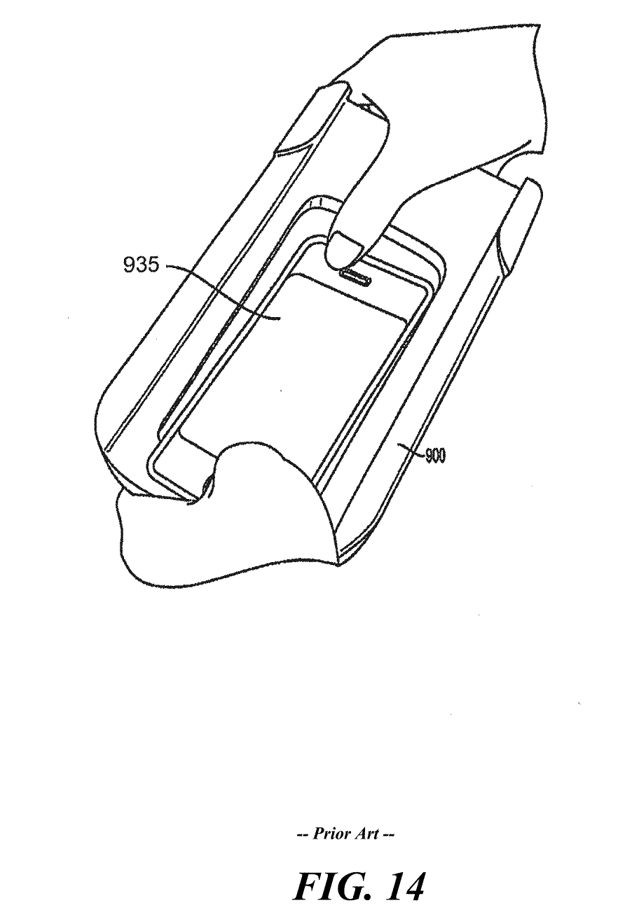

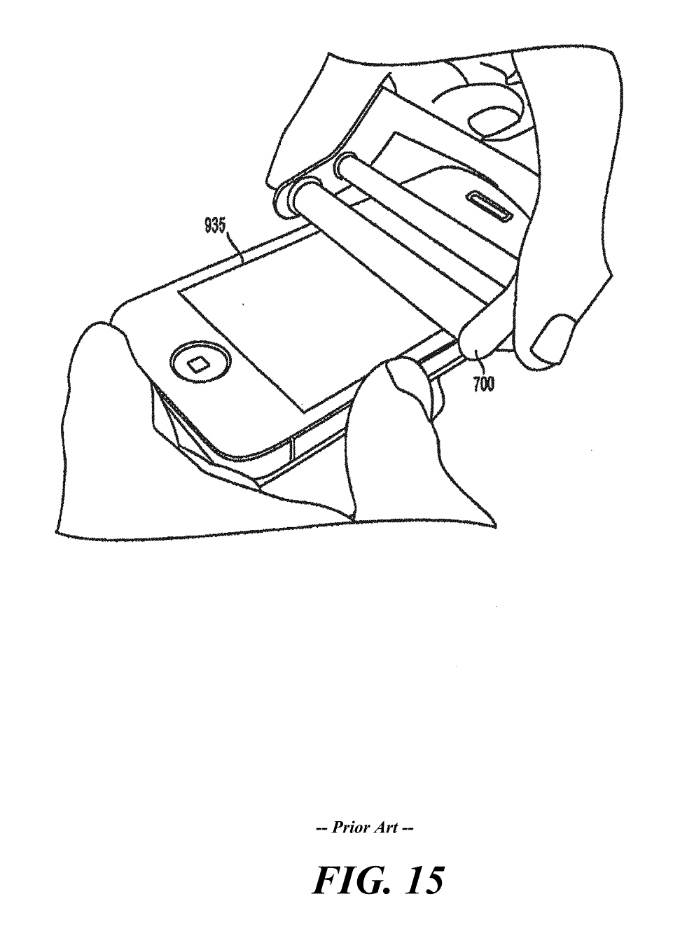

As shown in FIG. 14, the user may remove the mobile communication device 935 from the roller apparatus guide 900 by simply popping it out or lifting the roller apparatus guide 900 off the mobile communication device 935. If desired, the user may use the roller 700 and reinforce the applied film in the manner shown in FIG. 9H.

While the device disclosed in Chou is equipped with roller guiding rails 915 which may ostensibly prevent some of the lateral movement which is problematic in the device of Mason et al., as with the device of Mason et al., the device of Chou does an incomplete job of removing air bubbles from the protective film.

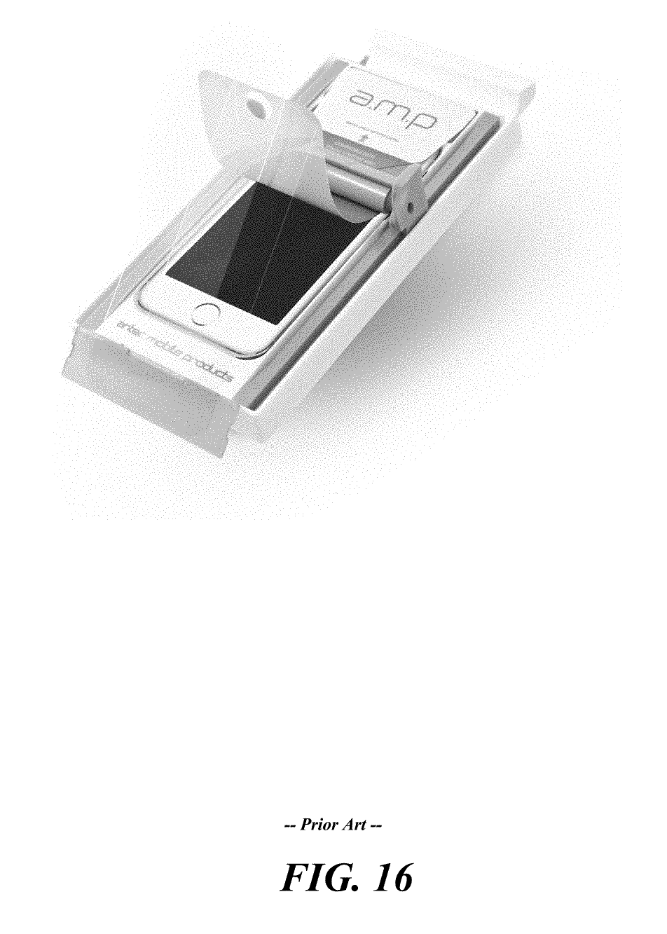

Similar devices to that of Chou are disclosed in U.S. 2015/0321416 (Patel et al.), U.S. 2014/0124146 (Patel et al.), U.S. 2013/0199714 (Patel et al.), U.S. 2012/0211171 (Patel et al.), U.S. 2012/0211170 (Patel et al.), U.S. Pat. No. 9,089,086 (Patel et al.), U.S. Pat. No. 9,033,019 (Patel et al.) and U.S. Pat. No. 9,010,396 (Patel et al.), which are commonly assigned with Chou. Various devices have been commercialized which appear to be based on the foregoing designs or on similar constructs, an example of which is shown in FIG. 16. However, none of these devices adequately remove air bubbles from the protective film.

It has now been found that the foregoing objective may be achieved with the devices and methodologies disclosed herein. In a preferred embodiment, these devices utilize a laterally constrained shuttle equipped with a resilient blade to apply a protective film to the display of a mobile technology platform and to remove any air bubbles present in the film at the time of application. In some embodiments, the movement of the shuttle is constrained by dual tracks which help to ensure proper orientation of the shuttle with respect to the substrate during film application.

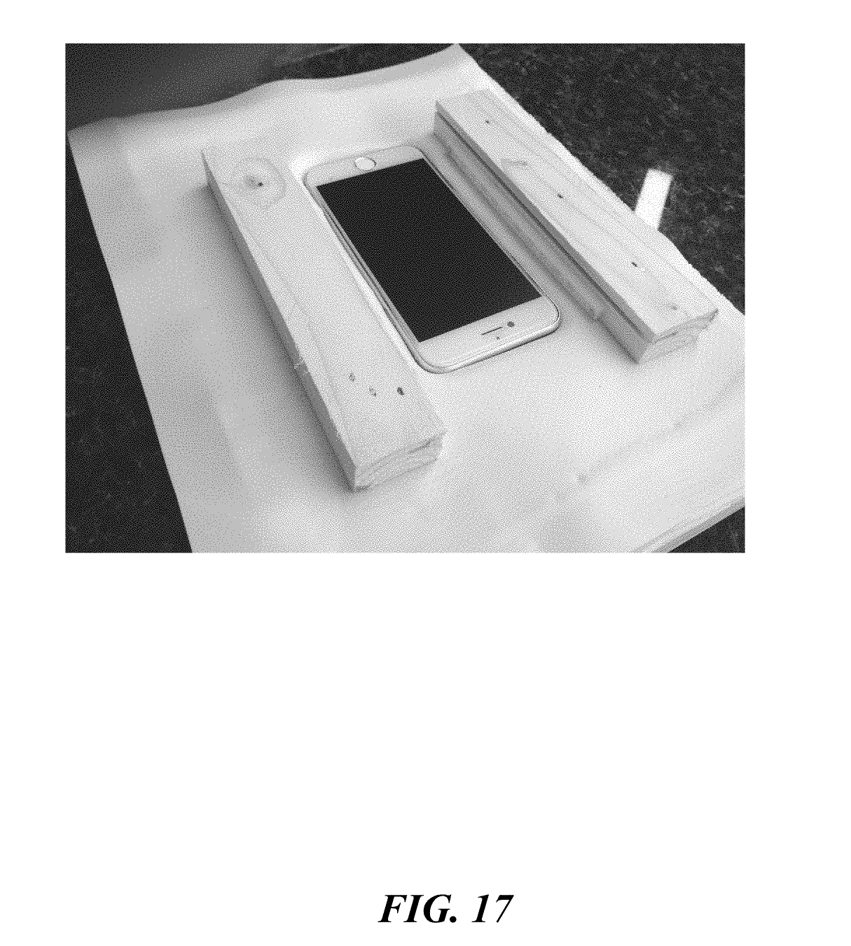

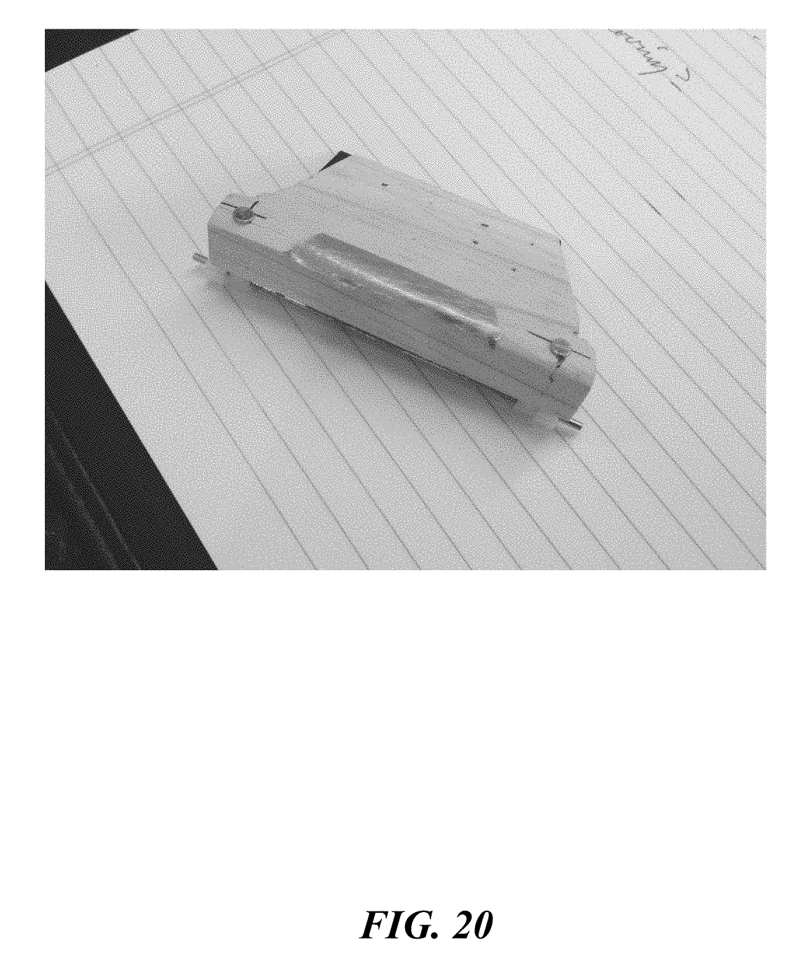

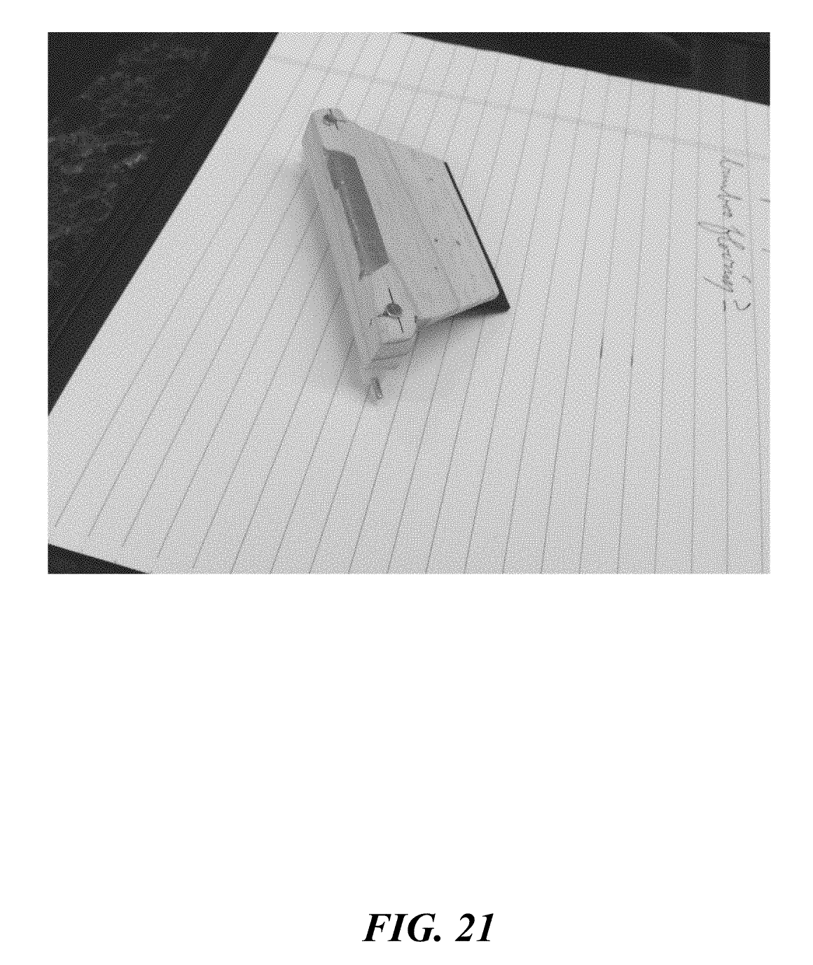

FIGS. 17-22 illustrate a first particular, non-limiting embodiment of a screen protector applicator in accordance with the teachings herein. One skilled in the art will appreciate that the embodiment illustrated is merely a crude prototype meant to illustrate the general attributes of the device, and that a more finished device may be smaller, may be made out of different materials, and may have other differences from the device depicted.

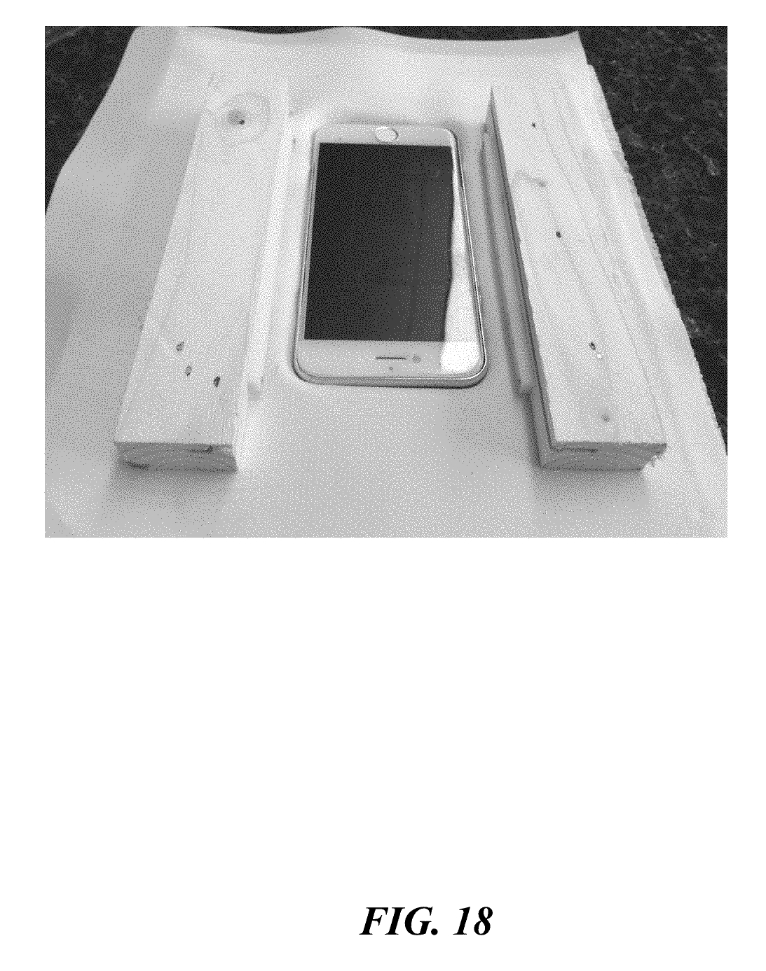

As seen in FIGS. 17-18, the screen protector applicator 301 depicted therein comprises a substrate 303 having a central depression 305 within which, during use, a mobile technology platform 307 is seated. The substrate 303 has a set of lateral elements 309 that are arranged in parallel thereon and which are spaced apart from, but adjacent to, opposing sides of the central depression 305. Each lateral element 309 has a longitudinal slot 311 in a surface thereof and a toothed rail 313 attached to an interior surface thereof. The longitudinal slot 311 and rail 313 are parallel to each other and to the surface of the display of the mobile technology platform 307.

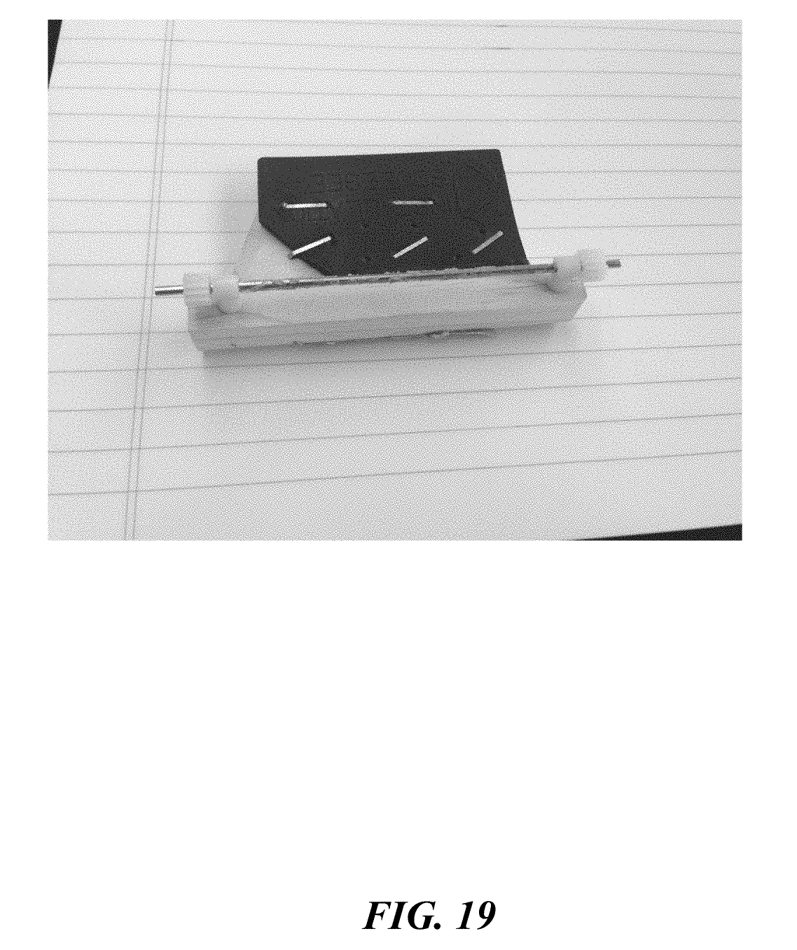

As seen in FIGS. 19-21, the screen protector applicator 301 is equipped with a shuttle 321 comprising a body 323 which includes a lip 325 and a planar portion 327 which is laterally attached to the lip 325. The planar portion 327 is generally trapezoidal in shape and has a blade 329 attached to a bottom surface thereof.

An axle 331 is rotatingly mounted on the lip 325 by way of a set of struts 333. The axle 331 has a set of toothed gears 335 rotatingly mounted thereon. Suitable apertures are provided in the struts 333 and gears 335 through which the axle 331 extends.

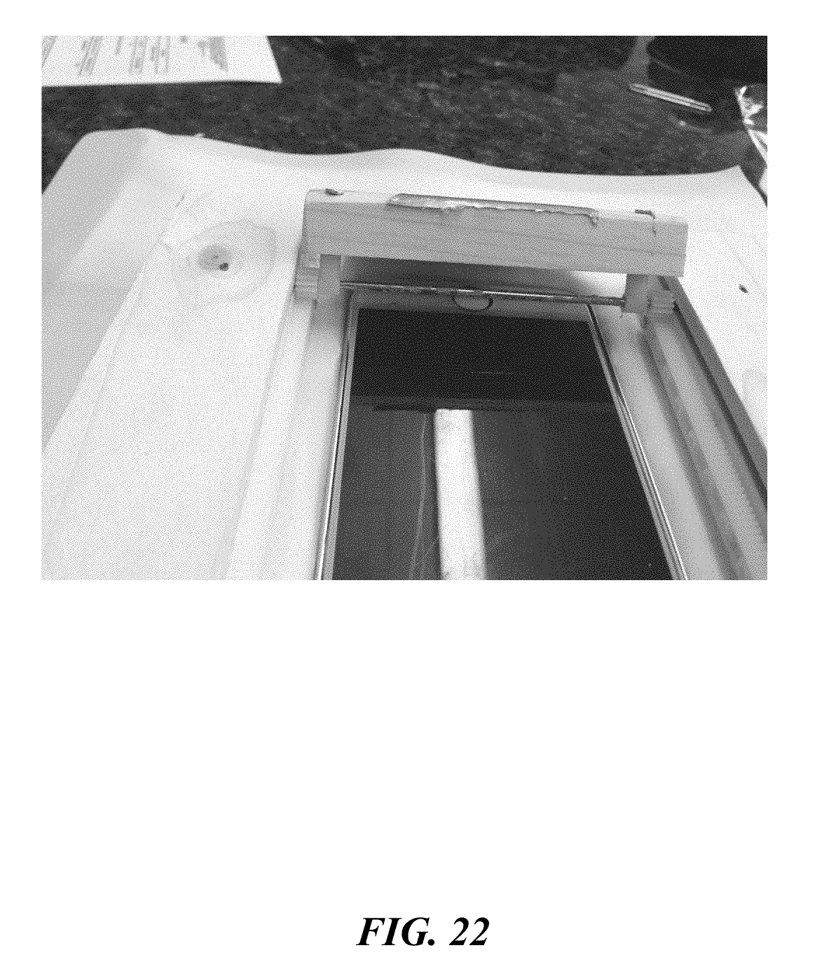

As seen in FIG. 22, the shuttle 321 is disposed in the screen protector applicator 301 such that each of the toothed gears 335 is mounted on one of the rails 313, and such that each portion of the axle 331 extending from one of the gears 335 engages one of the longitudinal slots 311. In some embodiments, the slots 311 may be coated with polytetrafluoroethlylene or another suitable material which imparts suitable slip properties thereto.

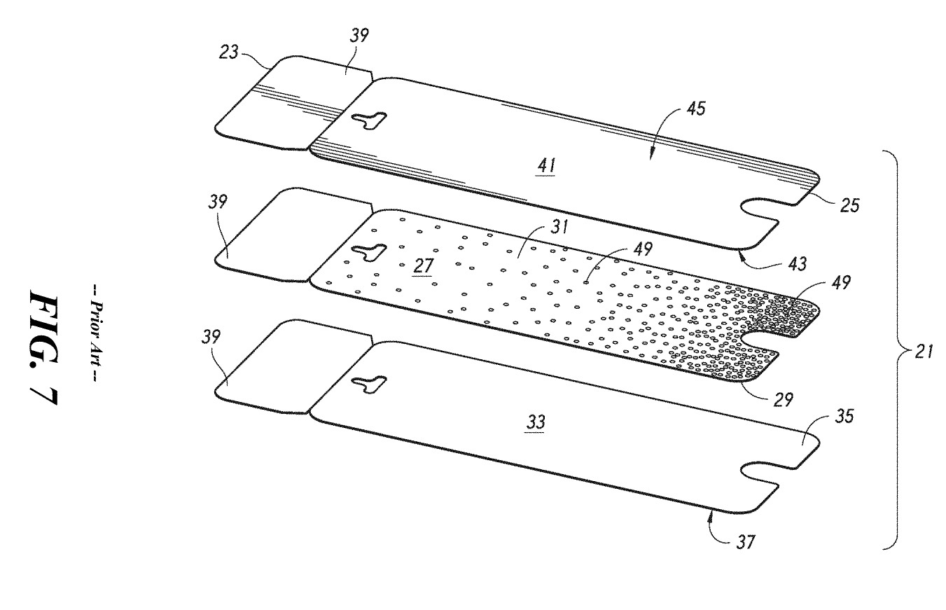

In use, the screen protector applicator 301 is used with a 3-part screen protection film of the type shown in FIG. 7. The release liner is removed from the film to expose the adhesive surface thereof, and the film is loosely positioned on the surface of the display of the mobile technology platform with the adhesive side down. With the shuttle 321 positioned adjacent to one end of the mobile technology platform 307, the cover film is peeled away from one end of the protective film and fed between the axle 331 and the lip 325. The shuttle 321 is then pushed along the lateral elements 309 and along the length of the display. As it moves along the display, the blade 329 pressingly engages the film and forces out any air bubbles trapped between the film and the display.

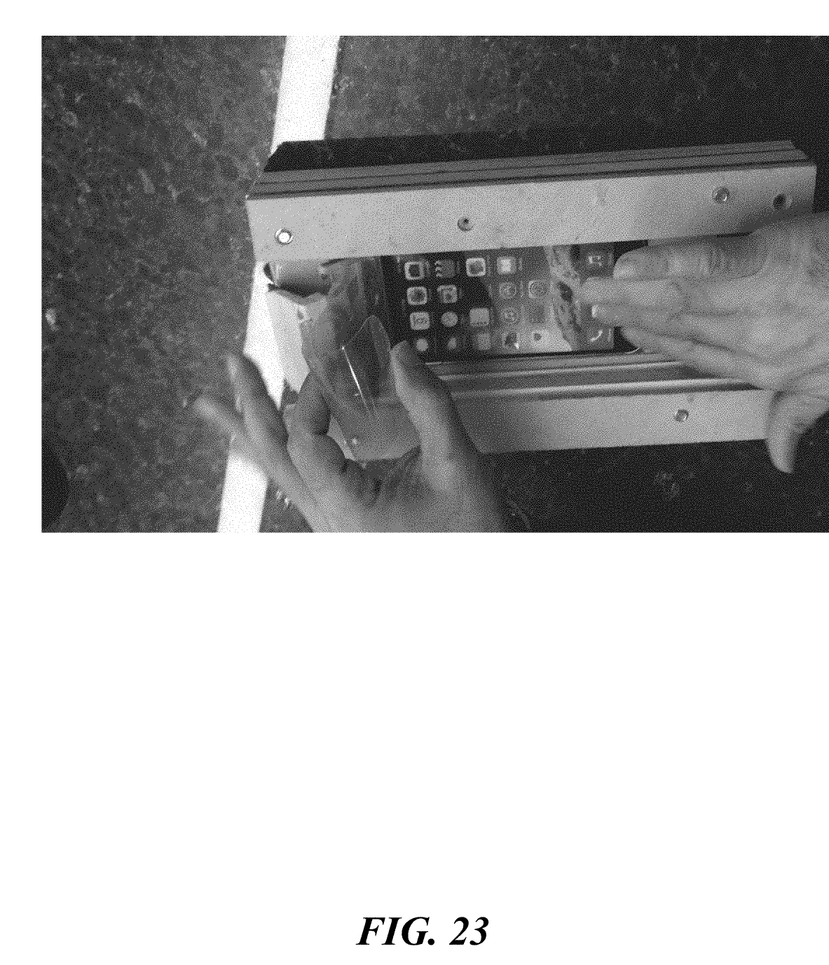

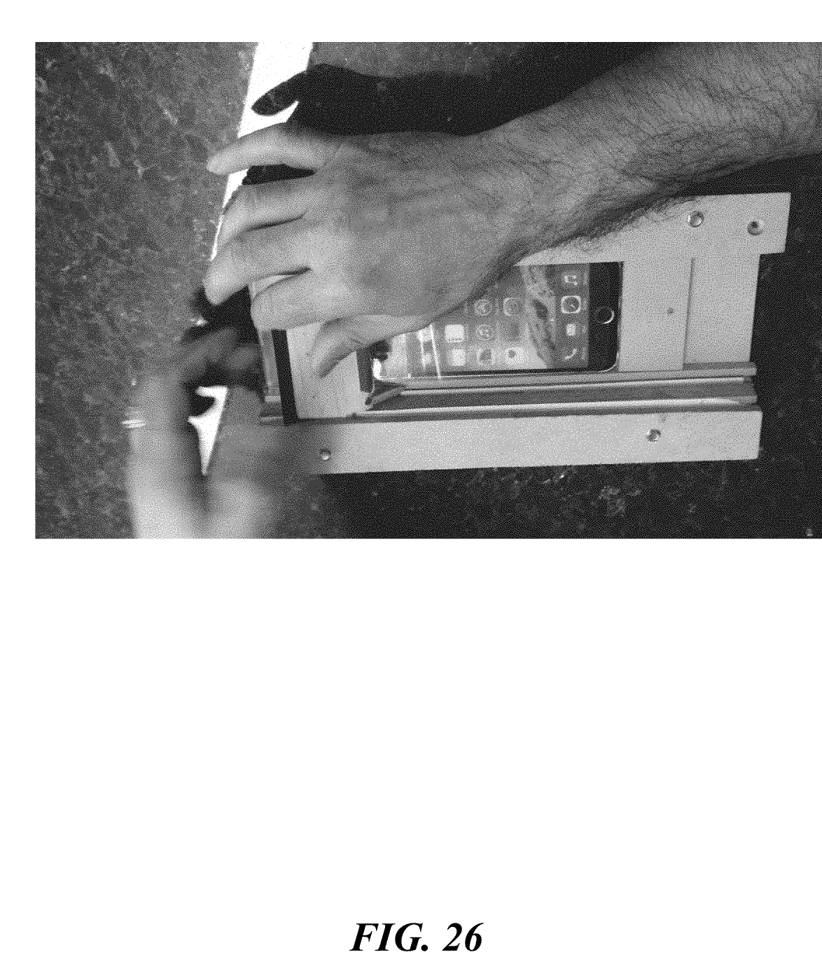

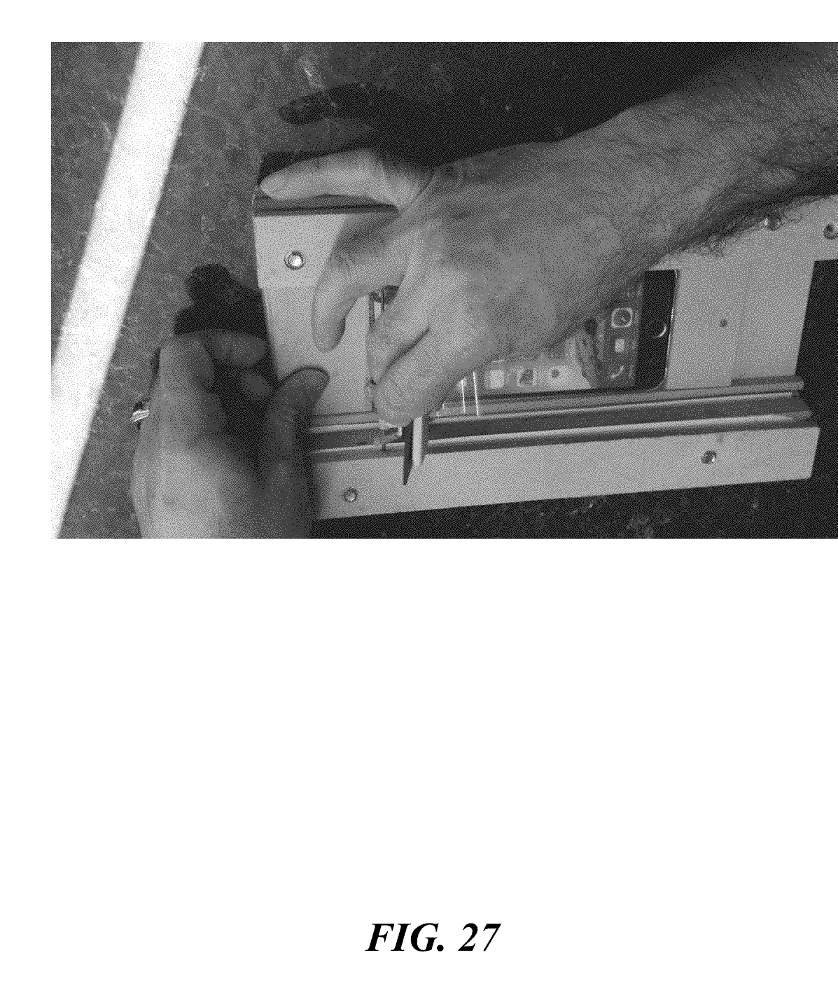

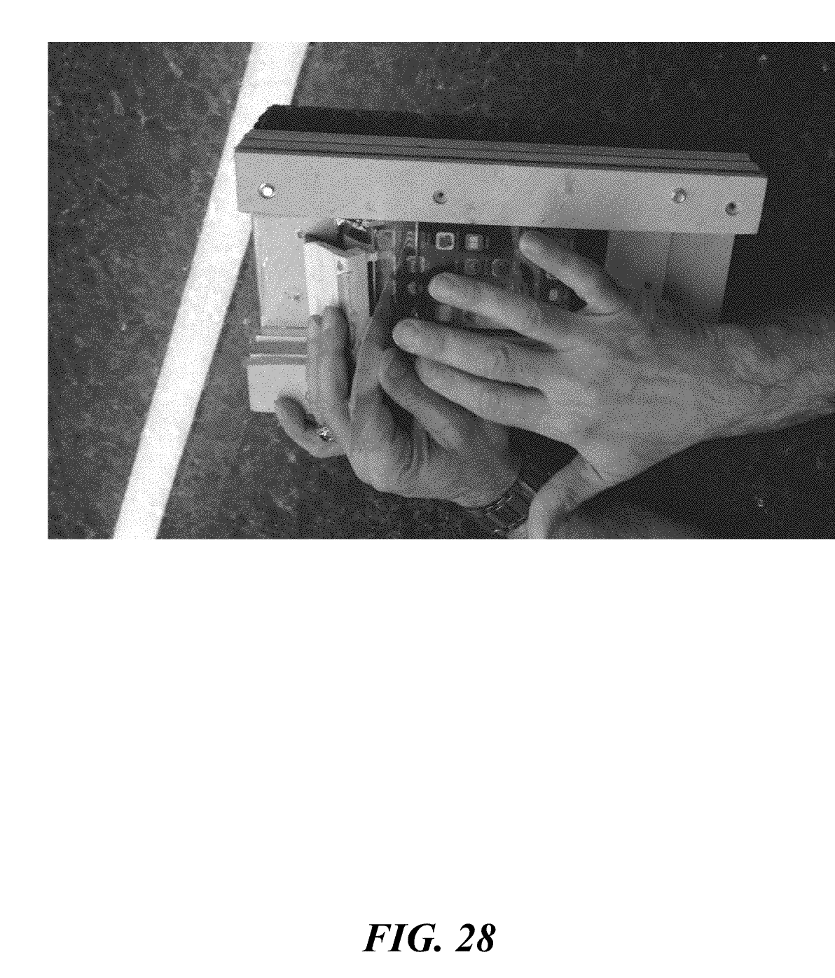

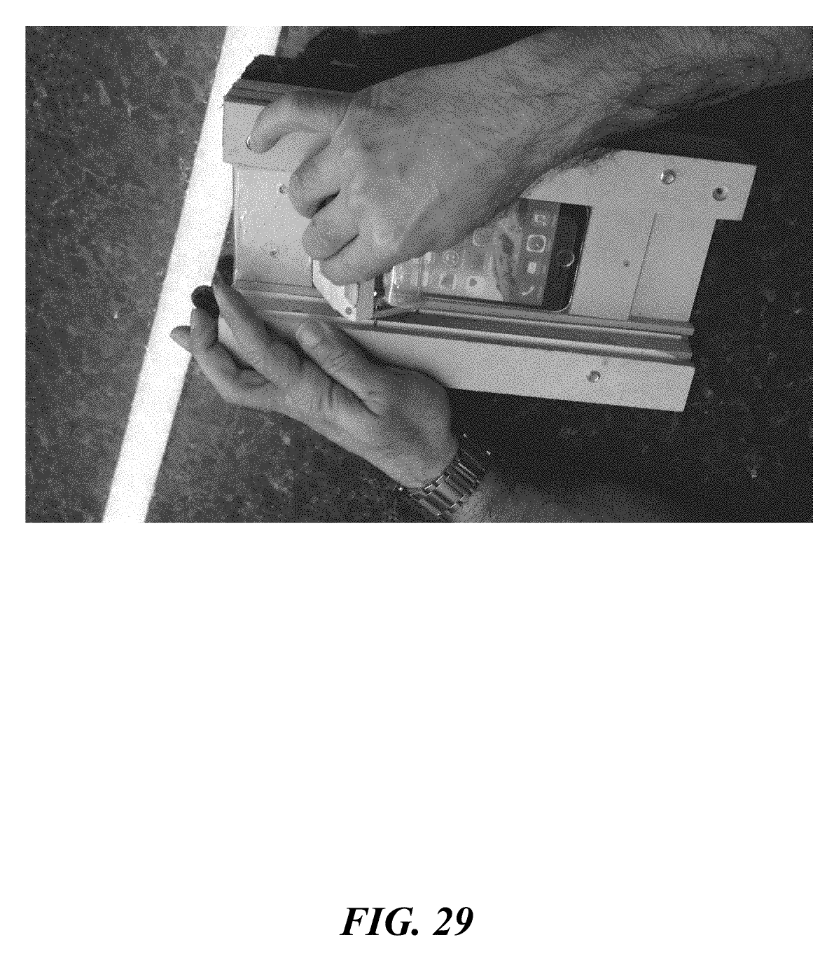

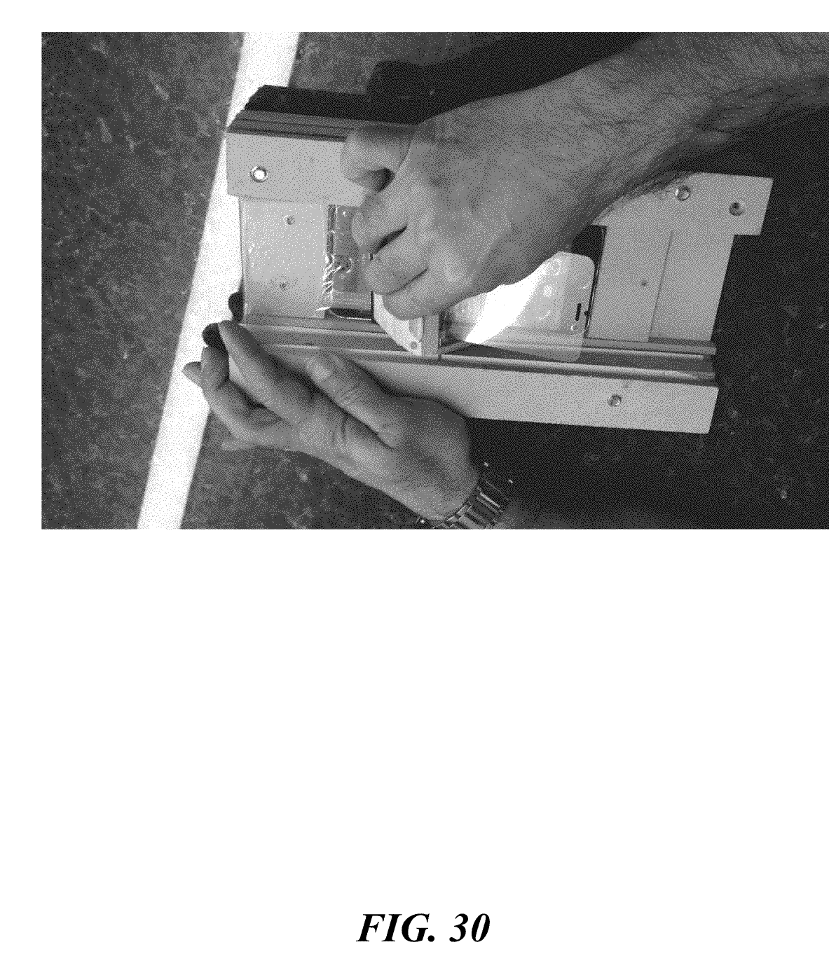

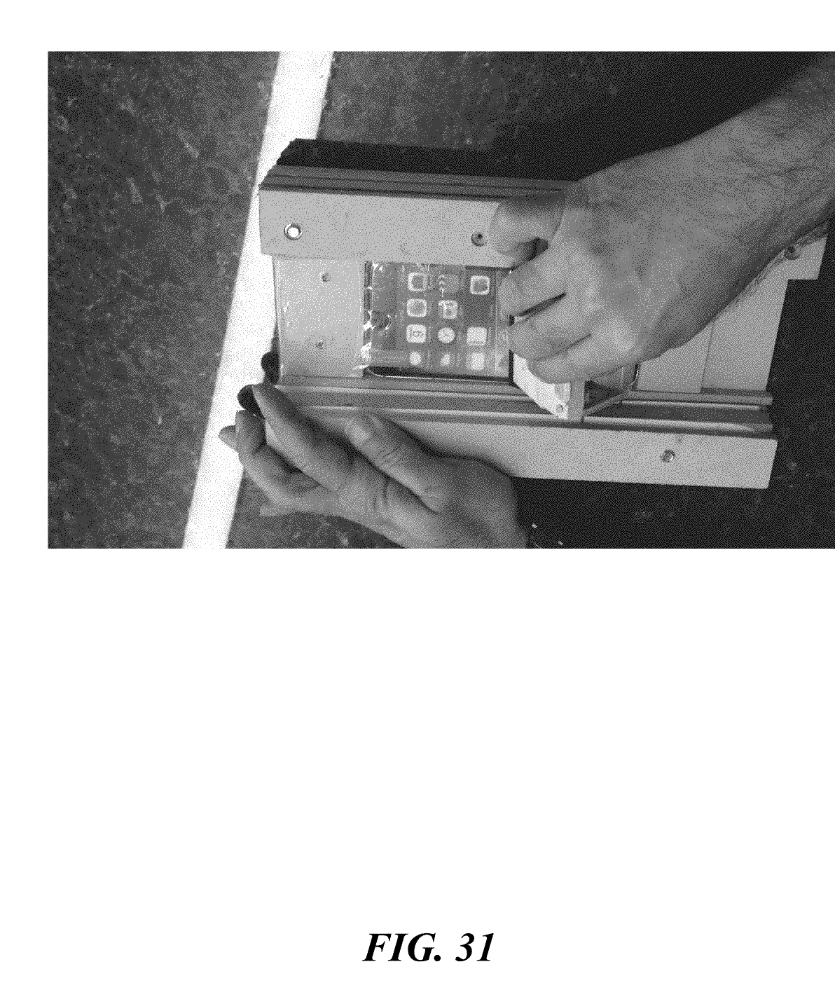

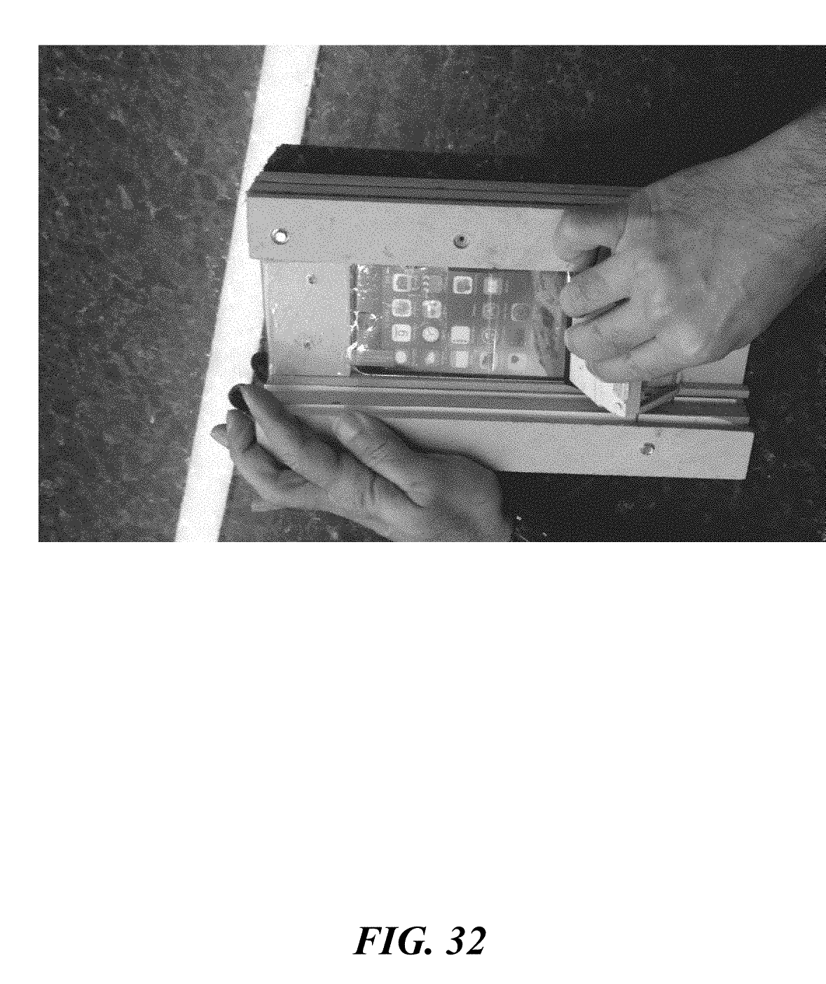

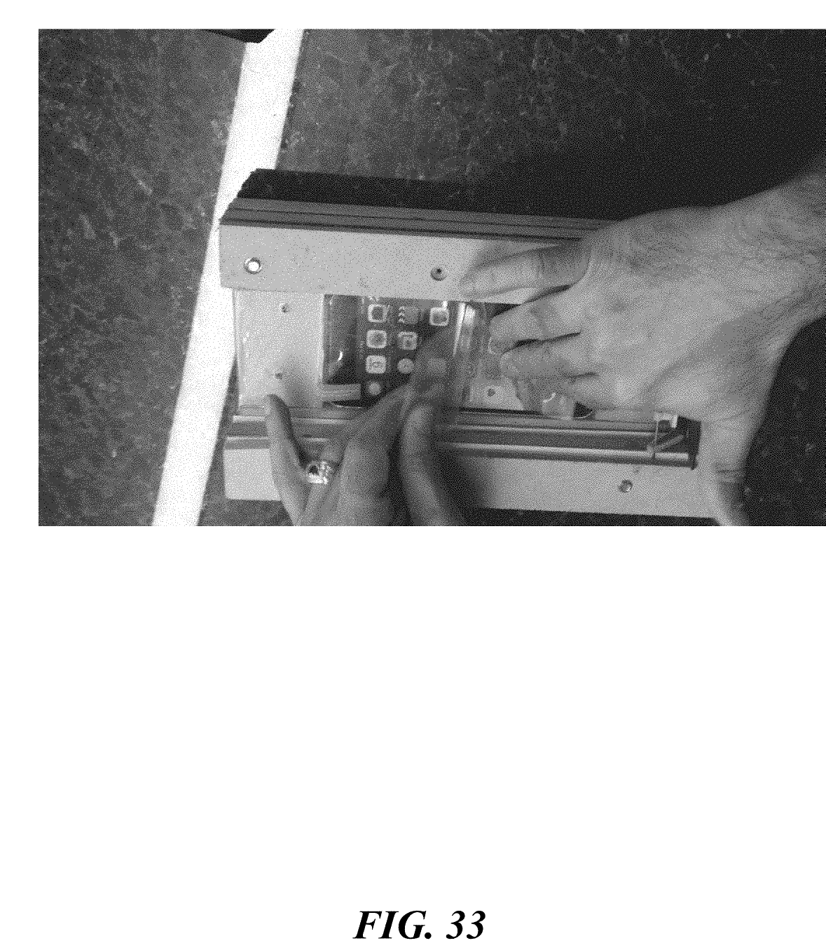

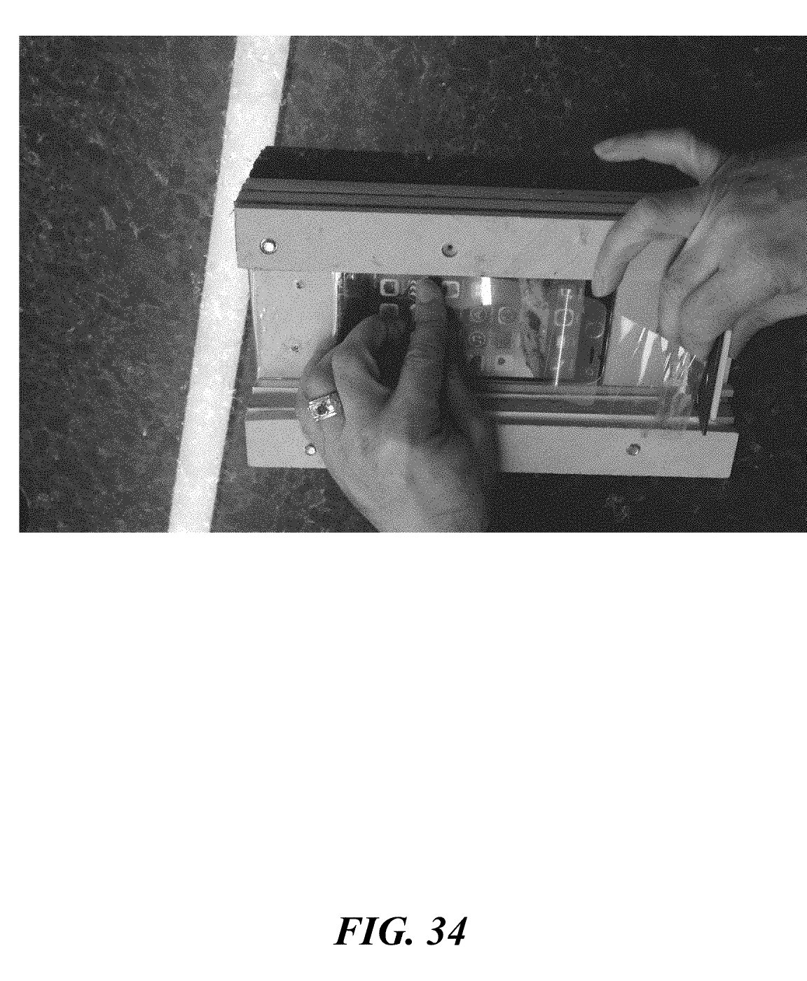

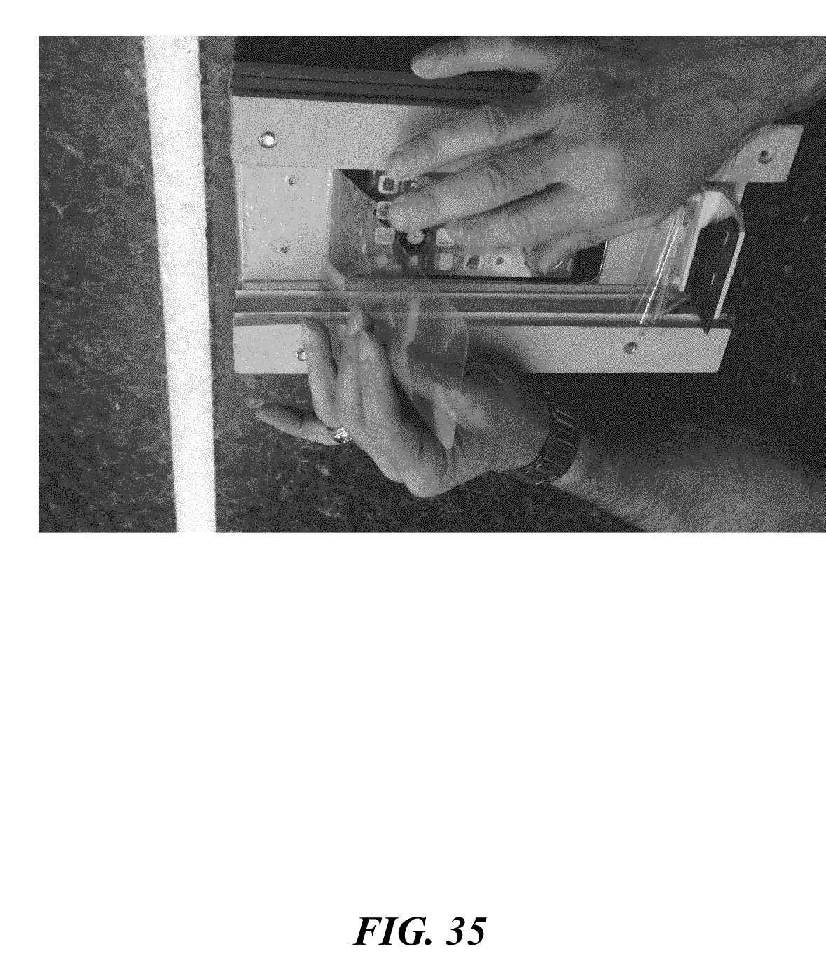

FIGS. 23-35 illustrate a second particular, non-limiting embodiment of a screen protector applicator 401 in accordance with the teachings herein. This embodiment is similar in many respects to the first embodiment. Thus, the screen protector applicator 401 depicted therein comprises a substrate 403 having a central depression 405 within which, during use, a mobile technology platform 407 is seated. The substrate 403 has a set of lateral elements 409 that are arranged in parallel thereon and which are spaced apart from, but adjacent to, opposing sides of the central depression 405. Each lateral element 409 has first 411 and second 412 longitudinal slots in a surface thereof. The first 411 and second 412 longitudinal slots are parallel to each other and to the surface of the display of the mobile technology platform 407.

The screen protector applicator 401 is equipped with a shuttle 421 comprising a body 423 which includes a lip 425 and a planar portion 427 which is laterally attached to the lip 425. The planar portion 427 is generally trapezoidal in shape and has a blade 429 attached to a bottom surface thereof.

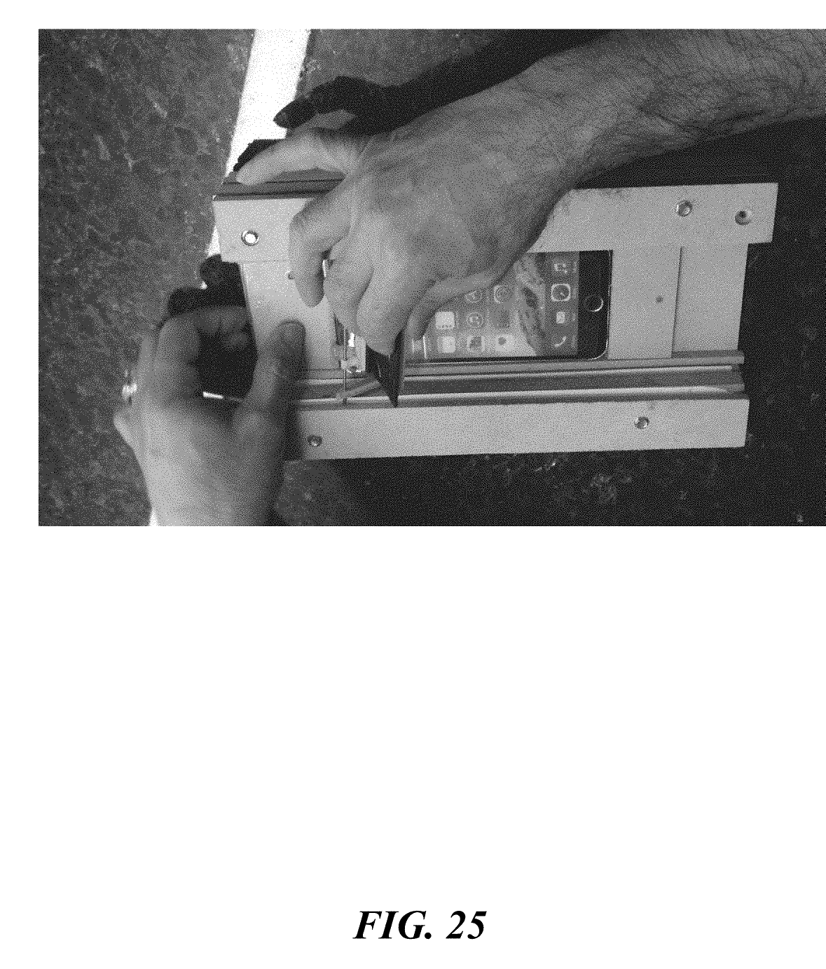

As best seen in FIG. 25, the shuttle 421 is further equipped with an axle assembly 430 which includes first 431 and second 432 axles which are connected by first and second rigid spacers 434. Each spacer 434 is equipped with first and second spaced apart holes through which the first 431 and second 432 axles extend, respectively. The first axle 431 is attached to the lip 425 by way of a set of struts 433 in the manner depicted in FIG. 19 for the previous embodiment. The second axle 432 is not attached to the shuttle 421, this allowing the second axle and the spacers 434 to pivot about the axis of the first axle 431.

As seen in FIG. 22, the shuttle 321 is disposed in the screen protector applicator 401 such that the portions of the first 431 and second 432 axles protruding from the spacers 434 engage the first 411 and second 412 longitudinal slots, respectively. In some embodiments, the first 411 and second 412 longitudinal slots may be coated with polytetrafluoroethlylene or another suitable material which imparts suitable slip properties thereto.

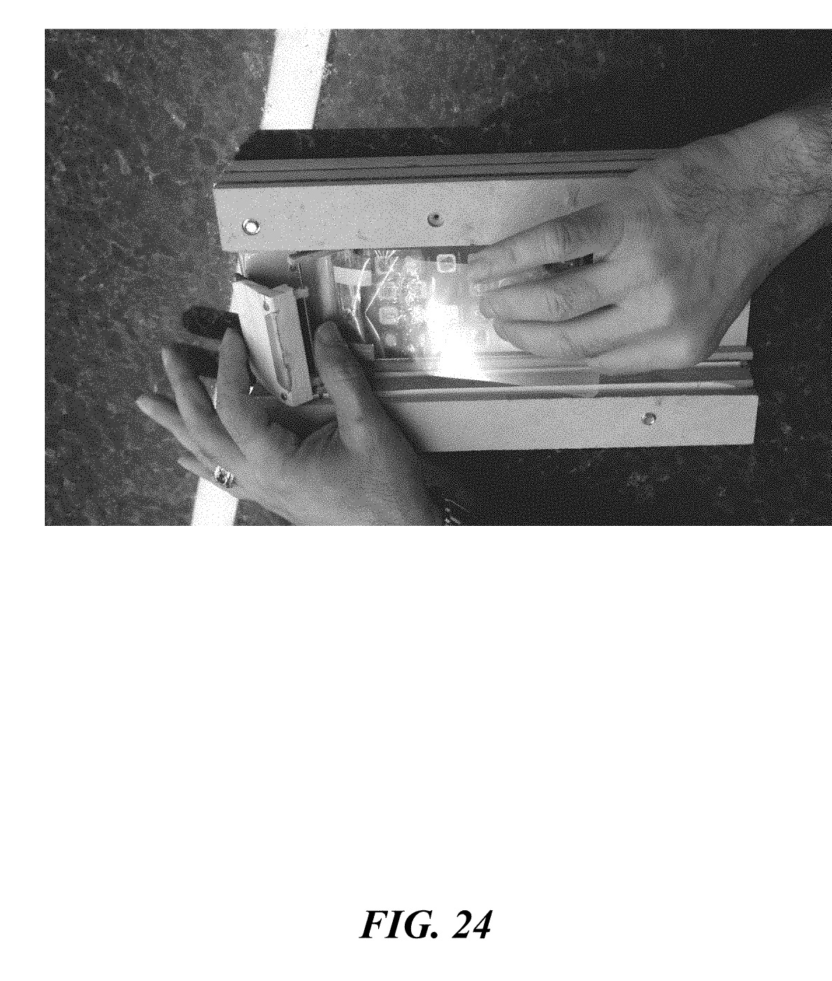

It will be appreciated that the foregoing orientation of the first 431 and second 432 axles with respect to the first 411 and second 412 longitudinal slots, combined with the ability of the shuttle 421 to rotate freely about the first axle 431, causes the blade 429 on the shuttle 421 to assume a sharply angled orientation with respect to the mobile technology platform 407. Such an orientation causes any bubbles in the applied protective film to be pressed out in the direction in which the shuttle 421 is traveling (see FIGS. 23-24) along the first 411 and second 412 longitudinal slots.

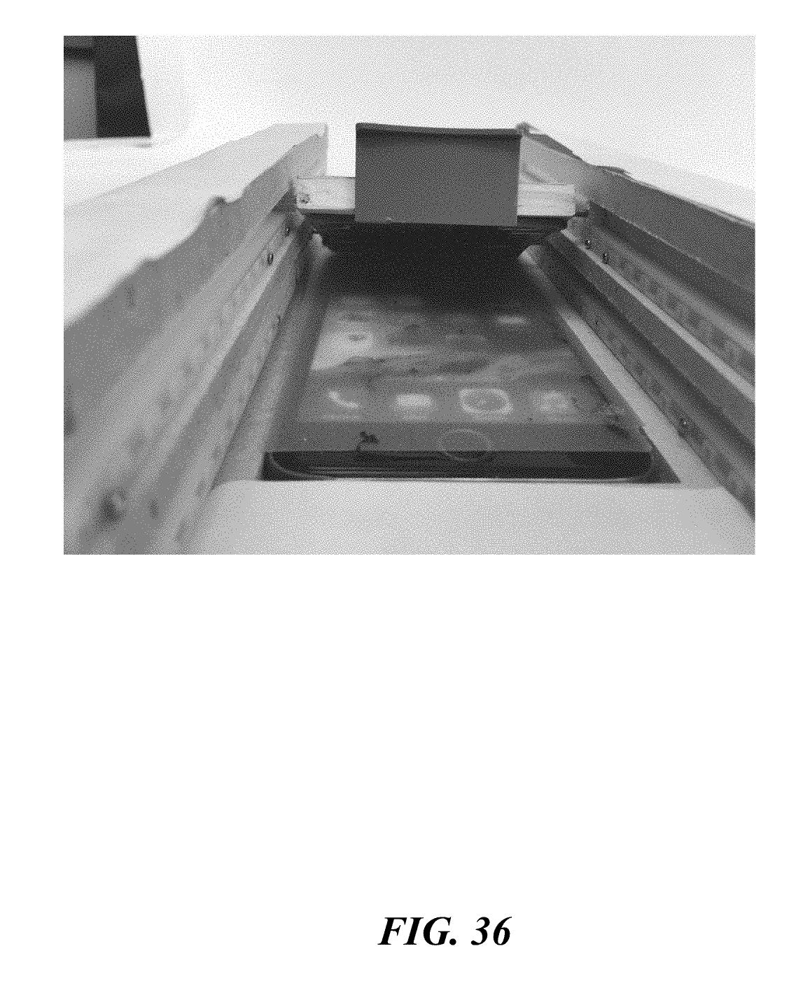

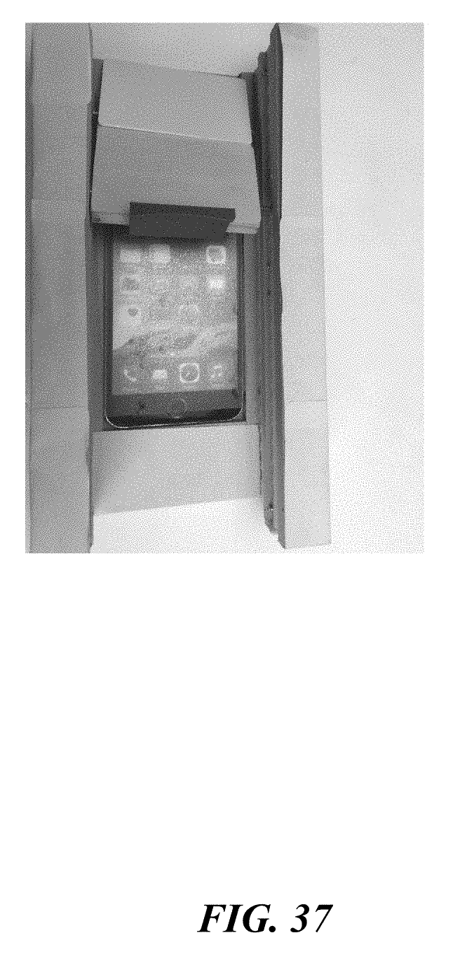

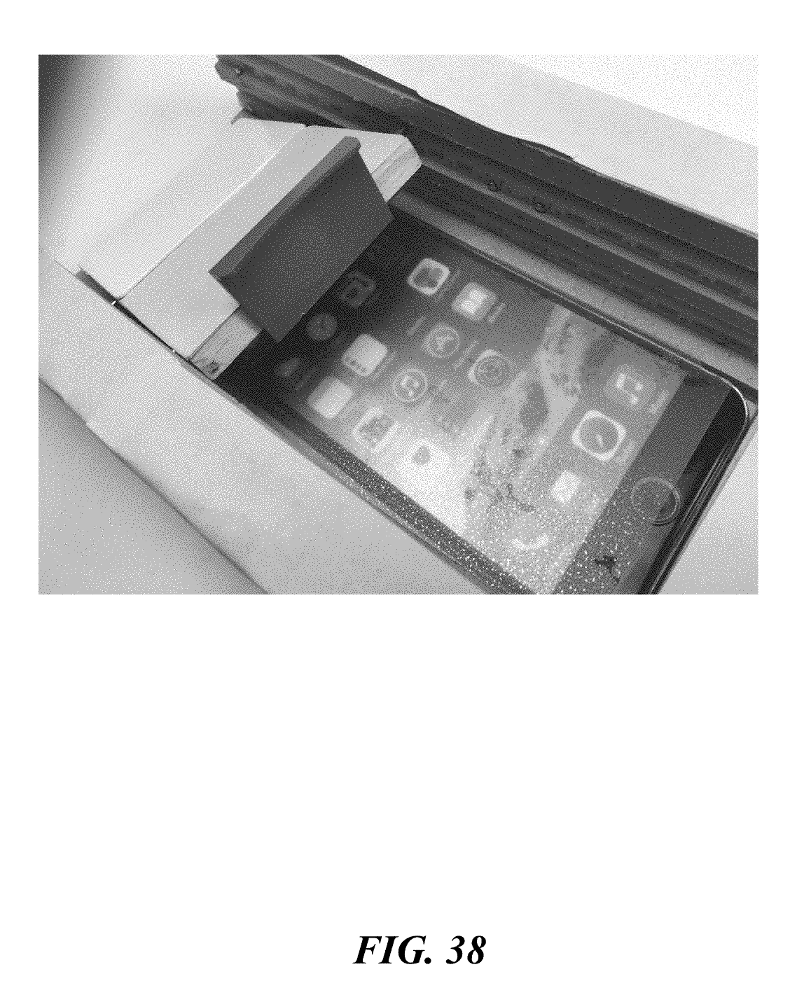

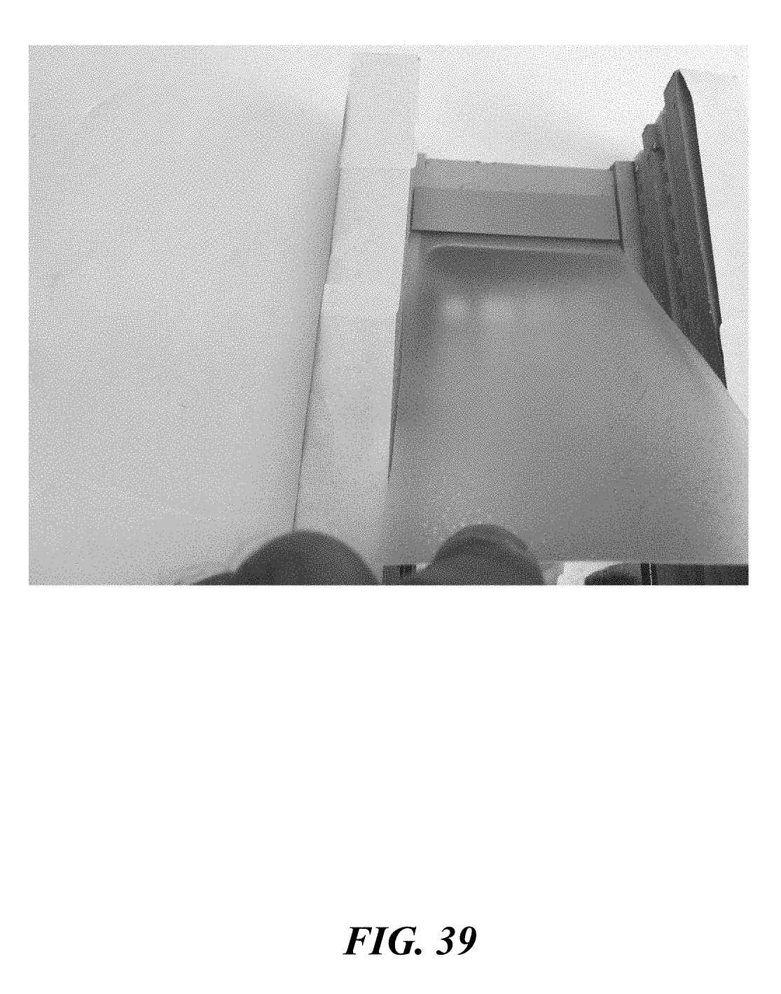

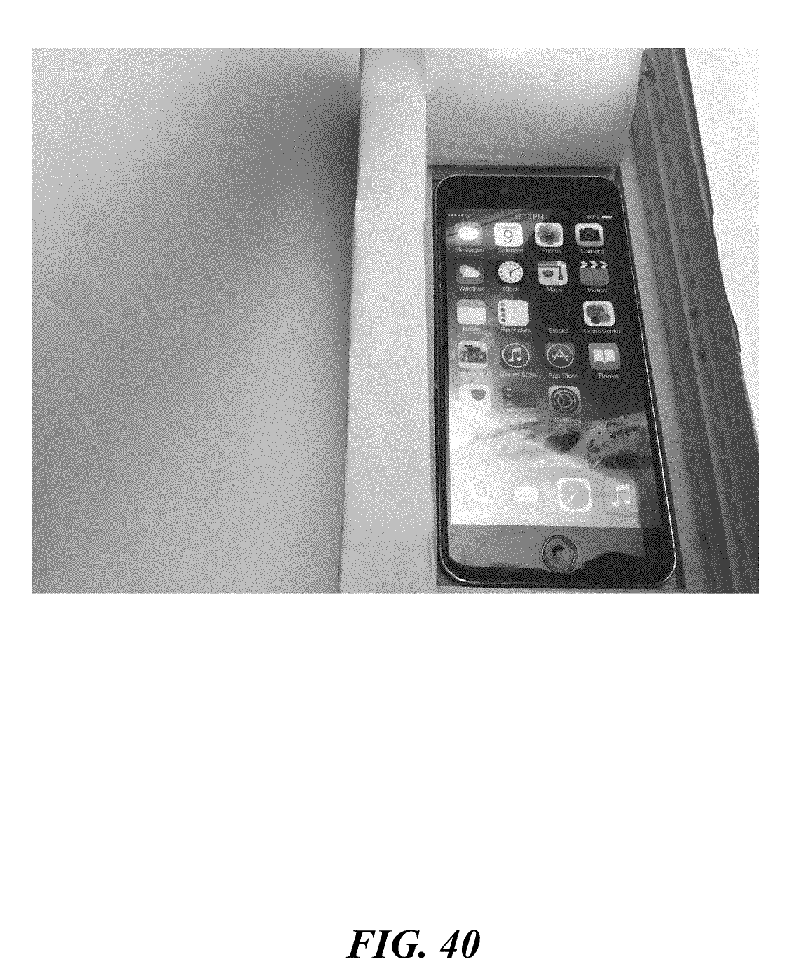

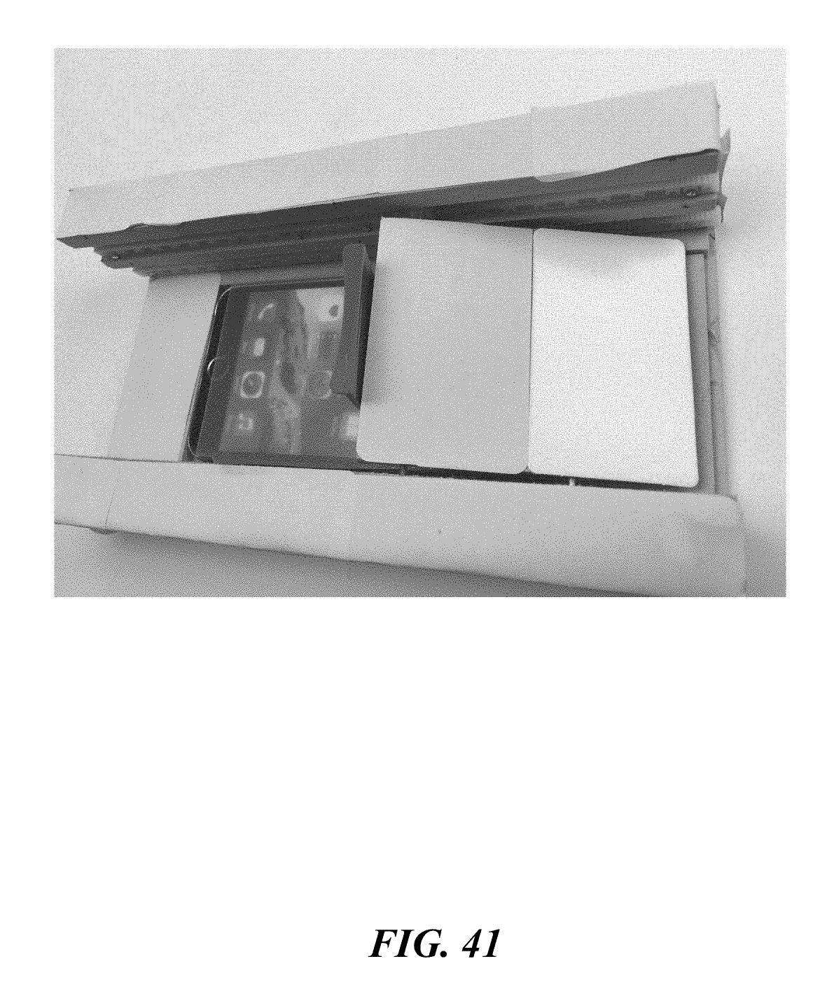

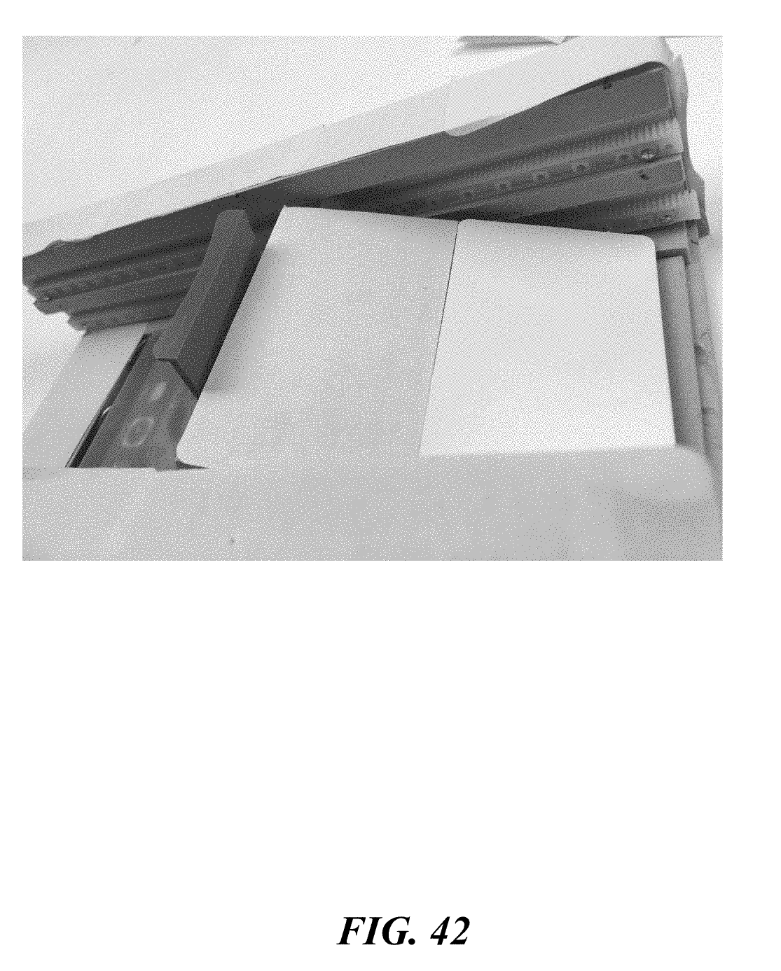

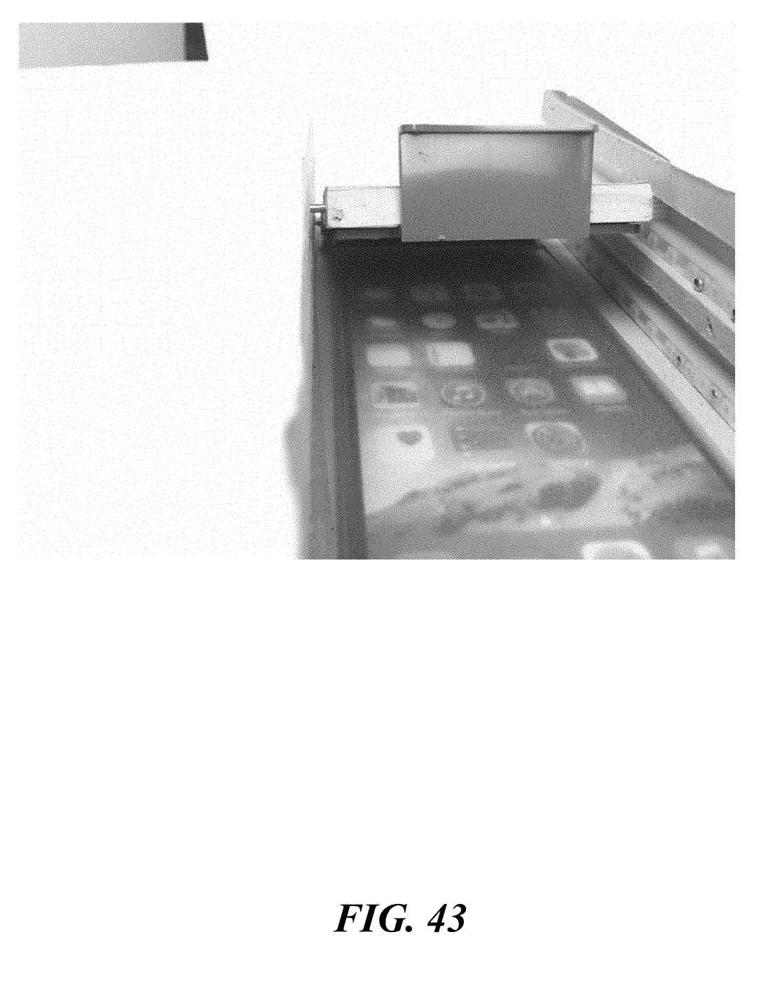

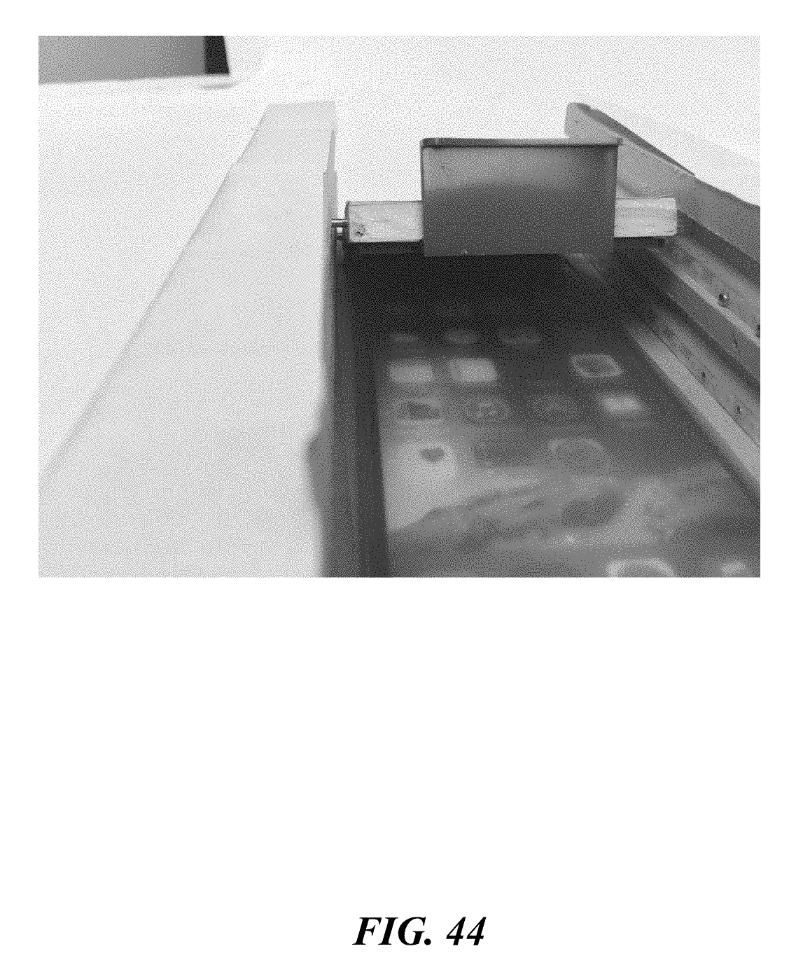

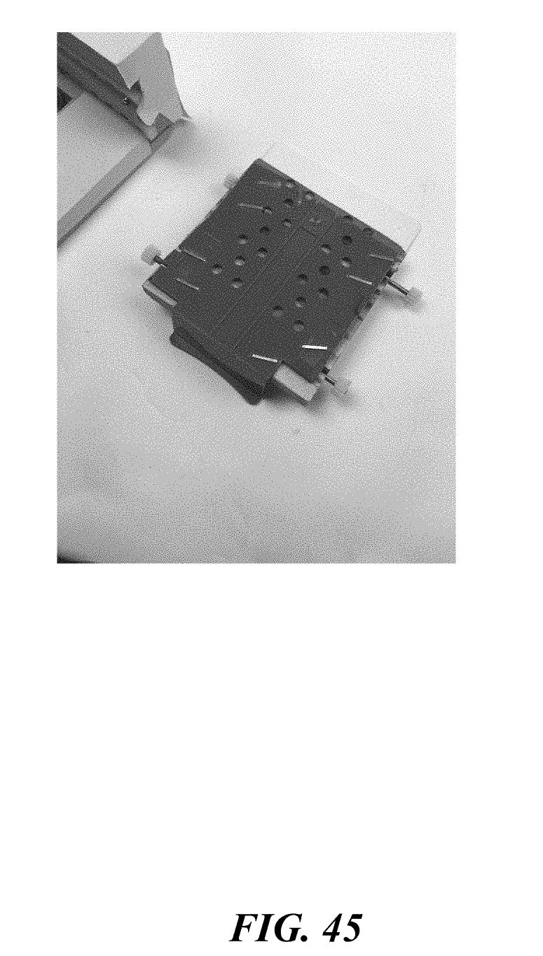

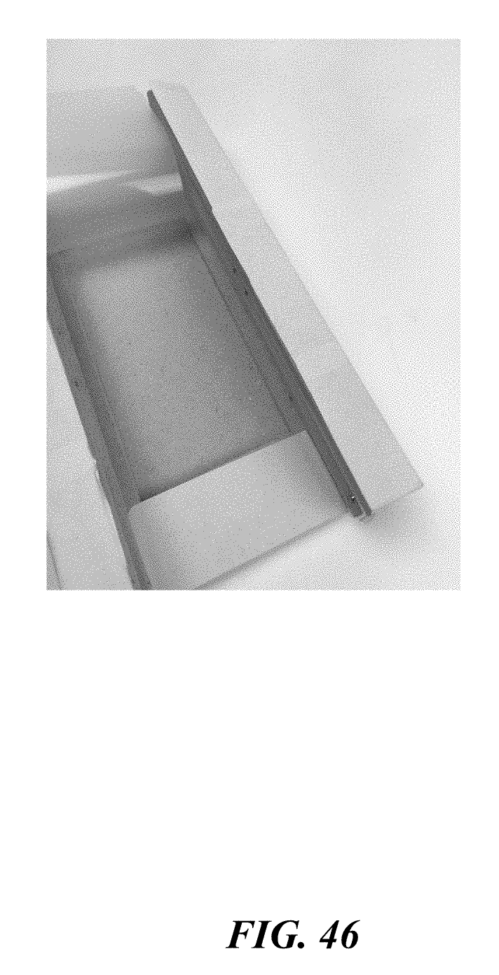

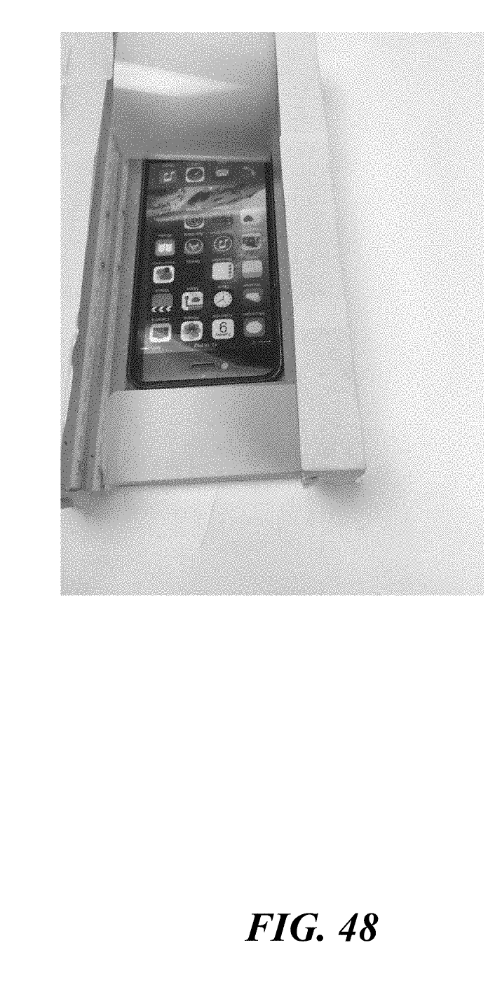

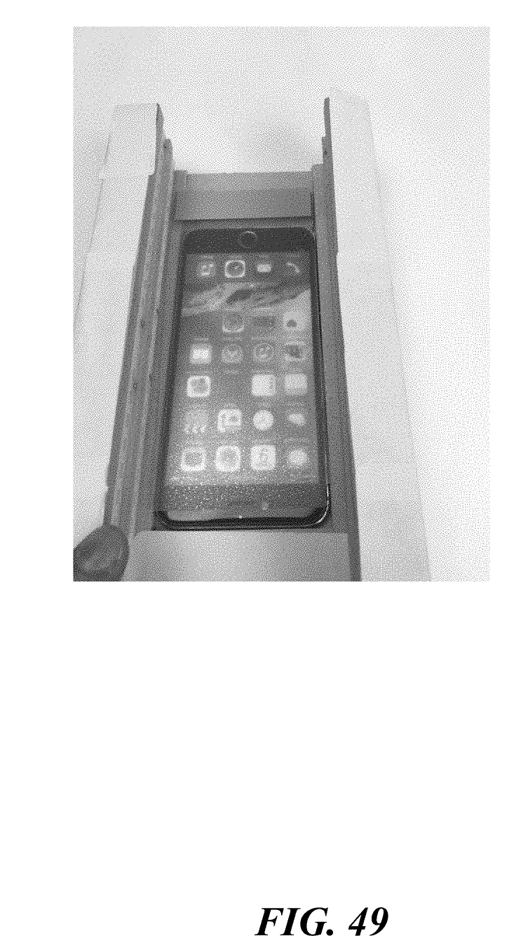

FIGS. 36-49 are perspective views of a third particular, non-limiting embodiment of a device in accordance with the teachings herein for applying a protective film to a mobile communications device. This embodiment is similar in many respects to the second embodiment and is utilized in a similar manner, but uses a somewhat different shuttle design.

The devices and methodologies disclosed herein may be utilized to apply protective films to a wide variety of mobile devices. These mobile devices may have a variety of form factors. In order to accommodate these different form factors without necessitating the provision of a separate applicator which is customized for each form factor, in some embodiments, the applicators disclosed herein may be equipped with a set of templates to accommodate different form factors. In such embodiments, each template will typically key to a specific mobile device form factor, and will also key to the central depression 405 in the substrate 403. For example, each template may have an interior opening which is complimentary in shape to the form factor of a specific mobile device or model thereof, and an exterior which is complimentary in shape to the central depression 405 in the substrate 403. Hence, use of the proper template for a mobile device ensures that the mobile device remains firmly seated in the central depression during film application.

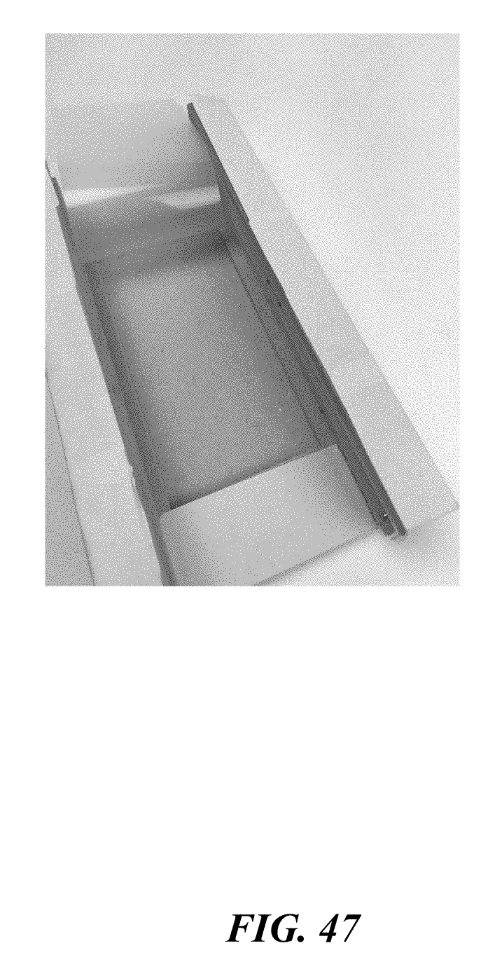

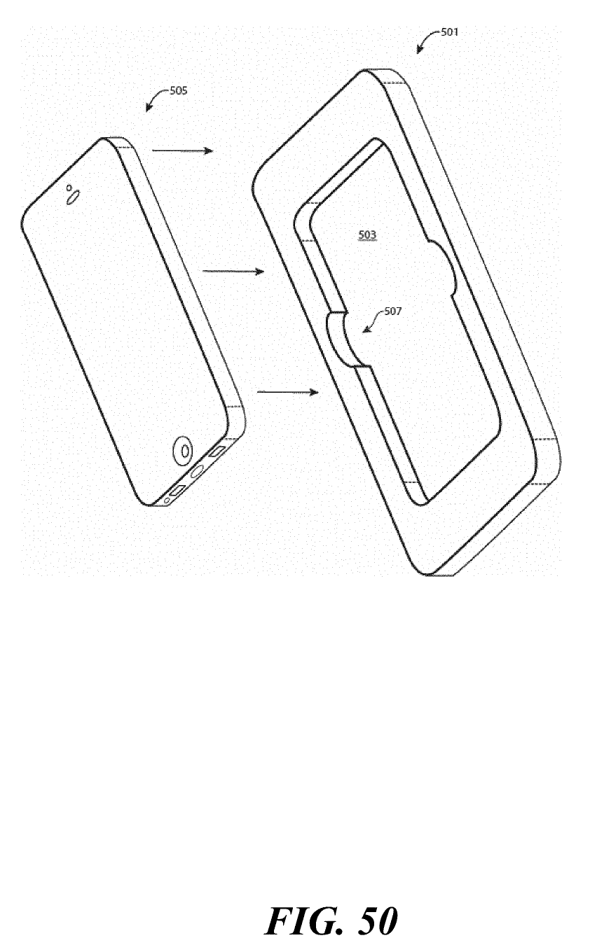

FIG. 50 depicts a particular, non-limiting embodiment of the foregoing type of template. As seen therein, the template 501 has an interior opening 503 which is complimentary in shape to the particular form factor of mobile device 505. The template 501 also has an exterior which is complimentary in shape to the central depression 405 (see, e.g., FIG. 47) in the substrate 403. The template 501 in this particular embodiment is also provided with a set of lateral indentations 507 to facilitate placement and removal of the mobile device 505 from the template 501.

The templates disclosed herein may be made out of various materials, with the particular choice of material typically being dictated by the specific application. For example, the templates may be constructed from various plastics or polymeric materials, wood, metals, or the like. The use of moldable plastics is especially preferred, since they may be readily formed to the contours of a mobile device having a specific form factor.

In one possible variation of the foregoing embodiment, rather than using templates, the substrate may be equipped with a central depression whose dimensions are readily adjustable in the lateral or longitudinal directions. This may be achieved, for example, by defining the central depression with walls which are movable along one or more tracks, and which may be locked into place through the provision of a suitable locking means (such as, for example, a thumb screw).

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. In combination with a mobile communications device equipped with a display, and a film equipped with an adhesive backing and a release liner, a tool for applying the film to the display, the tool comprising:
a substrate having a depression therein in which the mobile communications device is seated;
first and second opposing rails disposed on opposing sides of said depression; and
a film applicator which travels along said first and second rails; wherein the film applicator is equipped with a blade which pressingly engages said film as the film applicator which travels along said first and second rails.

2. The combination of claim 1, wherein said first and second wheels are disposed on a common axle.

3. The combination of claim 2, wherein said axle is attached to a chassis, and wherein said blade is attached to said chassis.

4. The combination of claim 3, wherein said blade trails said axle as said film applicator which travels along said first and second rails in a first direction parallel to said first and second rails.

5. The combination of claim 3, wherein said blade is elastomeric.

6. The combination of claim 1, wherein said film applicator is further equipped with first and second wheels which engage said first and second rails, respectively.

7. The combination of claim 6, wherein each of said first and second rails includes at least one toothed surface.

8. The combination of claim 6, wherein said first and second rails include first and second opposing toothed surfaces, respectively.

9. The combination of claim 8, wherein each of said first and second wheels is a sprocket which meshes with the toothed surfaces of the first and second rails, respectively.

10. The combination of claim A1, further comprising a plurality of templates, wherein each template has a peripheral surface which is complimentary in shape to said depression, and an interior opening which is complimentary in shape to a mobile device having a specific form factor.

11. The combination of claim 10, wherein the peripheral surface of each template abuts the lateral surfaces of said depression.

12. The combination of claim 11, wherein the interior opening of each template abuts the lateral surfaces of a mobile device having the form factor to which the template is directed.

13. In combination with a mobile communications device equipped with a display, and a film equipped with an adhesive backing and a release liner, a tool for applying the film to the display, the tool comprising:
a substrate having a depression therein in which the mobile communications device is seated;
first and second opposing, toothed rails disposed on opposing sides of said depression;
a film applicator which travels along said first and second rails and which, in doing so, pressingly engages the film against the display; wherein the film applicator is equipped with
(a) first and second toothed gears which mesh with said first and second rails, respectively, and
(b) a blade which pressingly engages said film.

14. The combination of claim 13, wherein said first and second wheels are disposed on a common axle.

15. The combination of claim 14, wherein said axle is attached to a chassis, and wherein said blade is attached to said chassis.

16. The combination of claim 15, wherein said blade trails said axle as said film applicator which travels along said first and second rails in a first direction parallel to said first and second rails.

17. The combination of claim 15, wherein said blade is elastomeric.

18. The combination of claim 13, further comprising a plurality of templates, wherein each template has a peripheral surface which is complimentary in shape to said depression, and an interior opening which is complimentary in shape to a mobile device having a specific form factor.

19. The combination of claim 18, wherein the peripheral surface of each template abuts the lateral surfaces of said depression.

20. The combination of claim 19, wherein the interior opening of each template abuts the lateral surfaces of a mobile device having the form factor to which the template is directed.

21. In combination with a mobile communications device equipped with a display, and a film equipped with an adhesive backing and a release liner, a tool for applying the film to the display, the tool comprising:
a substrate having a depression therein in which the mobile communications device is seated;
first and second opposing walls disposed on first and second opposing sides of said depression, wherein each of said first and second opposing walls has first and second longitudinal slots therein; and
a film applicator which is equipped with a blade and which is further equipped with first and second axles, wherein the end portions of said first and second axles slidingly engage said first and second slots, and wherein said blade pressingly engages said film as the film applicator travels along said first and second longitudinal slots.

22. The combination of claim 21, wherein said first axle is attached to a chassis, and wherein said second axle is attached to said first axle by way of a pair of spacers.

23. The combination of claim 22, wherein each of said spacers is rigid.

24. The combination of claim 22, wherein each of said spacers has first and second apertures therein through which said first and second axles protrude.

25. The combination of claim 22, wherein said blade is attached to said chassis.

26. The combination of claim 25, wherein said blade is elastomeric.

27. The combination of claim 25, wherein said blade trails said axle as said film applicator which travels along said first and second rails in a first direction parallel to said first and second longitudinal slots.

28. The combination of claim 21, further comprising a plurality of templates, wherein each template has a peripheral surface which is complimentary in shape to said depression, and an interior opening which is complimentary in shape to a mobile device having a specific form factor.

29. The combination of claim 28, wherein the peripheral surface of each template abuts the lateral surfaces of said depression.

30. The combination of claim 29, wherein the interior opening of each template abuts the lateral surfaces of a mobile device having the form factor to which the template is directed.
